(19) United States
(12) Patent Application Publication
(10) Pub. No.: US 2026/0307226 A1
(43) Pub. Date: Oct. 8, 2026

(54) SYSTEM, METHOD, AND APPARATUS FOR INSTALLATION OF AN ANCHOR ASSEMBLY

(71) Applicant: Food Grade Solutions, LLC, Fowler, CA (US)

(72) Inventor: James Tjerrild, Clovis, CA (US)

(21) Appl. No.: 19/172,029

(22) Filed: Apr. 7, 2025

(51) Int. Cl. B25B 31/00; F16M 13/02

(52) U.S. Cl. CPC B25B 31/00; F16M 13/02

(57) ABSTRACT

Embodiments include an installation tool for installing an anchor assembly in a wall structure, the installation tool comprising a plate body configured to engage the wall structure, the plate body defining a major hole and a plurality of minor holes positioned adjacent to the major hole. The installation tool further comprises at least one protrusion positioned adjacent to the major hole, extending substantially perpendicular to a substantially flat lower surface of the plate body, and configured for insertion into the wall structure, and a guide that defines an internal passageway between a first open end and an opposing second open end adjacent to the major hole. A central axis of the internal passageway extends at an oblique angle relative to the lower surface of the plate body. The installation tool further comprises a support configured to fixedly attach the guide to an upper surface of the plate body.

### BACKGROUND

The description that follows relates to a system, method, and apparatus for installing an anchor assembly in a ceiling or wall structure. More specifically, the description relates to an installation tool for installing an anchor assembly intended to be used in food processing, pharmaceutical processing, and other facilities that require a high degree of cleanliness or enhanced sanitation.

Food processing and pharmaceutical processing facilities typically use mounting assemblies to mount pipes, conduits, tubes, and the like to vertical and horizontal surfaces in the facility (e.g., walls and ceilings). Such mounting assemblies often include an anchor assembly at least partially embedded into the wall structure (or ceiling), and a strut assembly coupled to an external portion of the anchor assembly and configured to mount the pipe, conduit, tube, or other supported element on the wall structure.

Anchor assemblies often include internal components such as anchors that must be installed into the surface of the wall structure at a specific angle. The angle of such anchors ensures that the anchor assembly will stay in place when mounting a load, such as a conduit, pipe, or the like, to the strut assembly portion. For example, insulated wall panel products sold by Kingspan®, such as, e.g., QuadCore® wall panel system, and other similar systems have a compressible interior or core material made of foam (e.g., polyisocyanurate, polyurethane, or polystyrene) or the like and a hard exterior or cladding made of metal (e.g., aluminum, stainless steel, etc.) or the like. Certain anchors in anchor assemblies are configured to be installed at a particular angle that is ideal for gripping the foam interior of such wall panels and staying in place upon mounting a load to the strut assembly. If the user cannot install such anchors at the intended angle, the anchor assembly may not be able to withstand mounting the load for which the anchor assembly is rated. Care must also be taken to ensure that the anchor does not wander or shift during its insertion into the wall, so that the final angle of the anchor upon installation is the same as the initial angle of insertion. If the anchor does not remain at the accurate angle as the anchor moves through the wall panel, the anchor may cause the compressible interior of insulated wall panel products to crush or tear. Unintentional tearing and compression compromise the structure of the compressible interior such that an anchor may not be able to adequately grip the foam interior of such wall panels and thus may not stay in place for mounting a load.

Additionally, it may be desirable for mounting assemblies used in food processing and pharmaceutical processing facilities to have a smaller footprint. In order to meet such demands, the anchor assemblies included therein often have strict tolerances and reduced clearance between its internal components. As a result, during installation of such anchor assemblies, each anchor must be installed into the wall structure accurately and at the intended angle, so that the internal components of the anchor assembly align and engage as designed, and the full mounting assembly can be properly assembled and used.

Accordingly, there is still a need in the art for installation tools and methods for anchor assemblies that enable components of such anchor assemblies to be reliably installed at the intended and accurate angle.

### SUMMARY OF THE INVENTION

The invention is intended to solve the above-noted problem by providing, among other things, an installation tool capable of facilitating accurate and reliable installation of an anchor assembly into a wall structure at specific, intended angles, while only requiring a moderately or minimally sized installation hole in an outer surface of the wall structure.

This disclosure is particularly advantageous for use with an anchor assembly for installation in a wall, ceiling, or other support structure in a food processing facility or manufacturing area that includes laminated foam panels, as is commonly used in such areas (e.g., wall panel products such as Kingspan® Insulated Panels), for example, by providing a tool for installing components of an anchor assembly to said support structure at the intended angles.

One exemplary embodiment provides an installation tool for installing an anchor assembly in a wall structure. The installation tool comprises a plate body configured to engage the wall structure during installation of the anchor assembly. The plate body defines a major hole and a plurality of minor holes positioned adjacent to the major hole. The installation tool further comprises at least one protrusion positioned adjacent to the major hole and extending substantially perpendicular to a substantially flat lower surface of the plate body. The at least one protrusion is configured for insertion into the wall structure during said installation. The installation tool further comprises a guide having a first open end and an opposing second open end positioned adjacent to the major hole. The guide defines an internal passageway between the first open end and the second open end. A central axis of the internal passageway extends at an oblique angle relative to the lower surface of the plate body. The installation tool further comprises a support configured to fixedly attach the guide to an upper surface of the plate body.

Another exemplary embodiment includes a system comprising a first installation tool and a second installation tool for installing an anchor assembly in a wall structure. The first installation tool comprises a first plate body configured to engage the wall structure during installation of the anchor assembly. The first plate body defines an opening. The first installation tool further comprises a first guide extending through the opening in the first plate body and having a first open end located a first distance above an upper surface of the first plate body and a second open end located a second distance below a substantially flat lower surface of the first plate body, the first distance being greater than the second distance. The first guide defines a first internal passageway between the first open end and the second open end, and a central axis of the first internal passageway is substantially perpendicular to the lower surface of the first plate body. The second installation tool comprises a second plate body configured to engage the wall structure during installation of the anchor assembly. The second plate body defines a major hole and a plurality of minor holes positioned adjacent to the major hole. The second installation tool further comprises at least one protrusion positioned adjacent to the major hole and extending substantially perpendicular to a substantially flat lower surface of the second plate body. The at least one protrusion is configured for insertion into the wall structure during said installation. The second installation tool further comprises a second guide having a first open end and an opposing second open end positioned adjacent to the major hole. The second guide defines a second internal passageway between the first open end and the second open end. A central axis of the second internal passageway extends at an oblique angle relative to the lower surface of the second plate body. The second installation tool further comprises a support configured to fixedly attach the second guide to an upper surface of the second plate body.

Another exemplary embodiment provides a method for installing an anchor assembly in a wall structure having an outer wall panel and an internal thickness. The method comprises providing an installation tool, the installation tool comprising a plate body having a major hole and a plurality of minor holes disposed around the major hole, at least one protrusion extending from a substantially flat lower surface of the plate body near the major hole, and a guide mounted to an upper surface of the plate body at an oblique angle, the guide defining an internal passageway between a first open end and a second open end positioned adjacent to the major hole; inserting the at least one protrusion of the installation tool into an opening formed in the wall structure until the lower surface of the plate body engages the wall structure; guiding a first lateral anchor of the anchor assembly through the internal passageway of the guide, through the major hole, and into the opening in the wall structure; and inserting the first lateral anchor into the internal thickness of the wall structure at the oblique angle formed by the guide.

Another exemplary embodiment provides a kit for installing an anchor assembly in a wall structure having an outer wall panel and an internal thickness using a driving tool, the kit comprising: a shank configured for attachment to the driving tool at one end of the shank; a first nut driver attachable to an opposite end of the shank and configured to engage a first drive head of a first anchor of the anchor assembly; a second nut driver attachable to the opposite end of the shank and configured to engage a second drive head of a second anchor of the anchor assembly, wherein the opposite end of the shank is configured to be interchangeably coupled to the first nut driver or the second nut driver; and a drill stop coupled to a body of the shank and configured to stop a path of the driving tool once a given anchor reaches a desired depth into the internal thickness of the wall structure. According to aspects, the given anchor is coupled to the shank via either the first nut driver or the second nut driver depending on whether the given anchor is the first anchor or the second anchor, respectively. According to various aspects, the drill stop may be configured to stop a path of the driving tool upon engaging a first installation tool for inserting the first anchor into the wall structure substantially perpendicular to the outer wall panel. According to various aspects, the drill stop may be configured to stop a path of the driving tool upon engaging a second installation tool for inserting the second anchor into the wall structure at an oblique angle relative to the outer wall panel.

A better understanding of the invention will be obtained from the following detailed descriptions and accompanying drawings, which set forth illustrative embodiments that are indicative of the various ways in which the principals of the invention may be employed.

### BRIEF DESCRIPTION OF THE DRAWINGS

FIG. 1 is a cross-sectional side view of an exemplary wall mounting assembly attached to a wall panel, the wall mounting assembly including an anchor assembly and an exemplary mounting bracket or strut assembly, in accordance with certain embodiments;

FIG. 2 is a side view of the anchor assembly shown in FIG. 1, in accordance with certain embodiments;

FIG. 3 is a top perspective view of a first exemplary installation tool, in accordance with certain embodiments;

FIG. 4 is a bottom perspective view of the first installation tool shown in FIG. 3, in accordance with certain embodiments;

FIG. 5 is a side view of the first installation tool shown in FIG. 3, in accordance with certain embodiments;

FIG. 6 is a top view of the first installation tool shown in FIG. 3, in accordance with certain embodiments;

FIG. 7 is a side view of an exemplary central anchor of the anchor assembly shown in FIG. 2, in accordance with certain embodiments;

FIG. 8 is a cross-sectional view of the central anchor shown in FIG. 7, in accordance with certain embodiments;

FIG. 9 is a side view of the central anchor shown in FIG. 7 attached to exemplary installation components, in accordance with certain embodiments;

FIGS. 10A and 10B depict an exemplary use of the first installation tool shown in FIG. 3 while installing the central anchor shown in FIG. 9, in accordance with certain embodiments;

FIG. 11 is a top perspective view of a second exemplary installation tool, in accordance with certain embodiments;

FIG. 12 is a bottom perspective view of the installation tool shown in FIG. 11, in accordance with certain embodiments;

FIG. 13 is a top view of the installation tool shown in FIG. 11, in accordance with certain embodiments;

FIG. 14 is a bottom view of the installation tool shown in FIG. 11, in accordance with certain embodiments;

FIG. 15A is a side view of the installation tool shown in FIG. 11, in accordance with certain embodiments;

FIG. 15B is a side view of a guide included in the installation tool shown in FIG. 15A, in accordance with certain embodiments;

FIG. 16 is a side view of an exemplary lateral anchor of the anchor assembly shown in FIG. 2, in accordance with certain embodiments;

FIG. 17 is a cross-sectional view of the lateral anchor shown in FIG. 16, in accordance with certain embodiments;

FIG. 18 is a side view of another exemplary lateral anchor, in accordance with certain embodiments;

FIG. 19 depicts an exemplary use of the installation tool shown in FIG. 11 while installing the lateral anchor shown in FIG. 16, in accordance with certain embodiments;

FIG. 20 is a top view of an exemplary bracket included in the anchor assembly of FIG. 2, in accordance with certain embodiments;

FIG. 21 is a side perspective view of the bracket of FIG. 20, in accordance with certain embodiments;

FIG. 22 is a top view of an upper crown included in the anchor assembly of FIG. 2, in accordance with certain embodiments;

FIG. 23 is a side view of the upper crown of FIG. 22, in accordance with certain embodiments;

FIG. 24A is a bottom view of the upper crown of FIG. 22, in accordance with certain embodiments;

FIG. 24B is a first cross-sectional view of the upper crown shown in FIG. 24A, in accordance with certain embodiments;

FIG. 24C is a second cross-sectional view of the upper crown shown in FIG. 24A, in accordance with certain embodiments;

FIG. 25 is a flow diagram for an exemplary method of installing an anchor assembly in a wall structure, in accordance with certain embodiments;

FIG. 26A-C depict an exemplary installation manual illustrating steps for installing an anchor assembly in a wall structure, in accordance with certain embodiments;

FIG. 27A is a perspective view of an exemplary installation kit, in accordance with certain embodiments;

FIG. 27B is a close-up perspective view of an exemplary hole saw of the installation kit shown in FIG. 27A, in accordance with certain embodiments;

FIG. 27C is a close-up perspective view of an exemplary spade of the installation kit shown in FIG. 27A, in accordance with certain embodiments;

FIG. 27D is a close-up perspective view of an exemplary driver assembly of the installation kit shown in FIG. 27A, the driver assembly coupled to an exemplary lateral nut driver, in accordance with certain embodiments; and

FIG. 27E is a close-up perspective view of the driver assembly of FIG. 27D coupled to an exemplary central nut driver of the installation kit shown in 27A, in accordance with certain embodiments.

Illustrative and exemplary embodiments of the invention are described in further detail below with reference to and in conjunction with the figures.

### DETAILED DESCRIPTION OF DRAWINGS

The description that follows describes, illustrates and exemplifies one or more embodiments of the invention in accordance with its principles. This description is not provided to limit the invention to the embodiment(s) described herein, but rather to explain and teach the principles of the invention in order to enable one of ordinary skill in the art to understand these principles and, with that understanding, be able to apply them to practice not only the embodiment(s) described herein, but also any other embodiment that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers or serial numbers in cases where such labeling facilitates a clearer description. Additionally, the drawings set forth herein are not necessarily drawn to scale, and in some instances, proportions may have been exaggerated to more clearly depict certain features. As stated above, this specification is intended to be taken as a whole and interpreted in accordance with the principles of the invention as taught herein and understood by one of ordinary skill in the art.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

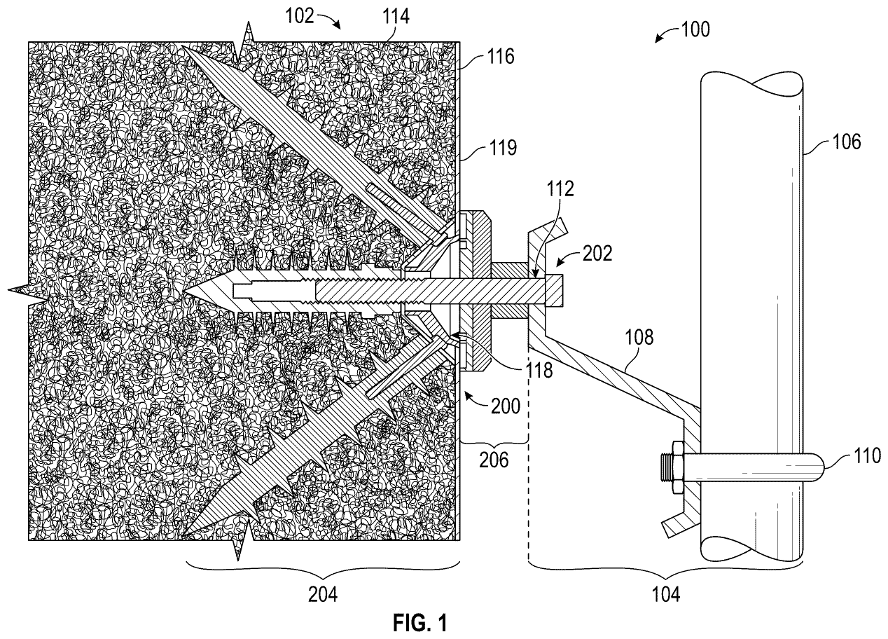

FIG. 1 is a cross-sectional side view of an exemplary wall mounting assembly 100 attached to a wall or wall panel 102 (also referred to herein as a “wall structure”), in accordance with embodiments. The wall mounting assembly 100 includes an anchor assembly 200 and a strut assembly 104 coupled to a supported element 106. The supported element 106 can be a pipe, conduit, tube, or the like. The strut assembly 104 includes a strut 108, or strut member, coupled to the anchor assembly 200 on one end and to the supported element 106 on the other end. The strut assembly 104 also includes a fastener 110 for securing the strut 108 to the supported element 106. The fastener 110 can be a U-bolt or any other suitable device for attaching the supported element 106 to the strut 108.

In embodiments, the strut 108 includes a hole 112 for receiving an elongated fastener 202 of the anchor assembly 200. The hole 112 can be configured to be at least large enough to receive a body of the elongated fastener 202 and smaller than a drive head of the elongated fastener 202, as will be appreciated.

As shown in FIG. 1, the strut 108 can be configured to angle the supported element 106 away from the wall structure 102, or at least substantially parallel to the wall structure 102. In embodiments, the strut 108 may be substantially similar to the strut shown and described in U.S. Pat. No. 7,651,056, filed on Oct. 12, 2005 and entitled “Method of Mounting Support Assemblies for Pipes, Conduits, and Tubes,” which has the same inventor as the present disclosure and is incorporated by reference herein in its entirety.

In embodiments, the wall or wall structure 102 can be comprised of a thick, inner portion 114 (also referred to herein as “inner wall portion” or “internal thickness”) overlaid by a thin panel 116 (also referred to herein as a “laminate outer cover”), as shown in FIG. 1. The inner portion 114 may be constructed of thick foam or foam board, or other sturdy, compressible material capable of being penetrated by the anchor assembly 200, but also capable of at least partially supporting a weight of the wall mounting assembly 100 and the supported element 106. The thin panel 116 may be a laminate cover or sheet metal cladding made of stainless steel or other material suitable for highly sanitary installations. The thin panel 116 may be attached to the inner portion 114 using adhesive or other suitable technique. In some embodiments, the thickness of the inner portion 114 can be, for example, between four and eight inches, while the thin panel 116 residing adjacent thereto can be significantly thinner (e.g., like a skin), as shown in FIG. 1. As an example, the wall 102 may be an insulated wall panel sold by Kingspan®, such as the Mineral Fiber (MF) Fire Rated wall panel.

In embodiments, to install the anchor assembly 200 in the wall structure 102, an opening or hole 118 may be formed through the wall panel 102 first. In certain embodiments, a size or diameter of the opening 118 (also referred to herein as an “installation hole”) may be selected based on sizes of one or more components of the anchor assembly 200, as described herein. Conventional anchor assemblies often require an installation hole that has a diameter of two inches or greater. A larger hole requires a larger component of the anchor assembly to cover the hole. Large, exposed surface areas found in conventional wall mounting assemblies can harbor contaminants including filth and mildew, as they tend to collect dust and debris along with water from wash downs. Alternatively, if the anchor assembly does not cover and seal the installation hole, small gaps or crevices can be difficult to inspect and clean. In embodiments, the anchor assembly 200 can be installed through a smaller hole than that required for conventional assemblies. In embodiments, the opening 118 has a diameter between about 1 and about 1.5 inches. In one exemplary embodiment, the opening 118 has a diameter of about 1.125 inches to match a standard hole saw size.

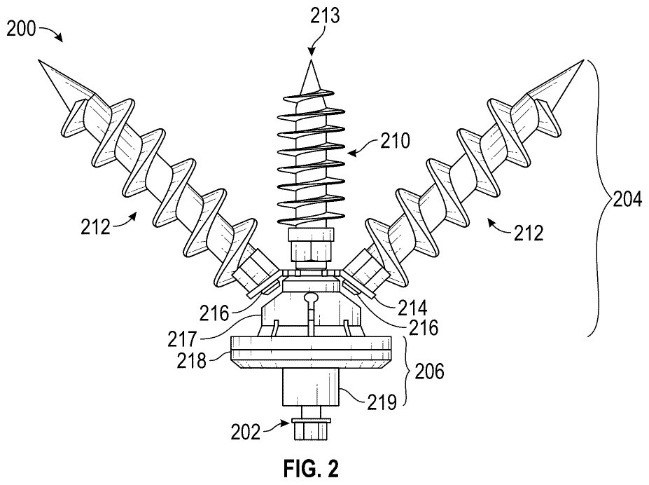

Referring additionally to FIG. 2, shown is a side view of the anchor assembly 200 in accordance with embodiments. The anchor assembly 200 is configured for mounting a supported element to a wall or other vertical or upright support, for example, as shown in FIG. 1. In some cases, the anchor assembly 200 may be used to mount a strut member to a horizontal surface, such as a ceiling.

As shown in FIG. 2, the anchor assembly 200 comprises a plurality of separate components that are configured (e.g., sized and shaped) to be assembled together to mount a strut member or other element to a wall or wall panel. The anchor assembly 200 includes the elongated fastener 202, an internal assembly 204, and an external assembly 206. According to embodiments, the internal assembly 204 is configured to engage the wall panel and be inserted into the wall panel. The external assembly 206 is configured for coupling to both the internal assembly 204 and the wall panel (e.g., the thin panel 116, as shown in FIG. 1). The elongated fastener 202 is configured for securing all of the separate components together and to the wall panel. As shown in FIG. 1, the external assembly 206 is configured to remain exposed or protrude out from the wall panel 102 after securing the anchor assembly 200 to the wall structure 102, for example, in order to receive the strut assembly shown in FIG. 1, and the internal assembly 204 is configured to extend into and attach to the internal thickness 114 of the wall structure 102.

In embodiments, the anchor assembly 200 is specifically configured to not only handle direct tension loads without causing a ceiling panel or wall structure to buckle or sag from the load, but also handle vectored loads without causing the anchors to be pulled out from the wall, for example, by installing each anchor at an appropriate angle. Thus, when mounted properly, the anchor assembly 200 is configured to resist tension forces along multiple load directions, including perpendicular or straight loads and vectored loads. Moreover, the anchor assembly 200 is configured to be installed within a wall without penetrating all the way through the wall structure or causing a backside of the wall to bulge, for example, by using anchor lengths that are appropriate for the thickness of the wall panel.

In embodiments, the anchor assembly 200 is especially designed for use in locations that require a high degree of cleanliness, such as food processing plants and pharmaceutical manufacturing installations. For example, one or more components of the anchor assembly 200, such as, e.g., the internal assembly 204, can be specifically configured for secure fastening to a laminate foam wall panel typically used in food processing plants and other industrial-level, clean environments (e.g., as shown in FIG. 1). Such wall panels include a compressible foam (or Styrofoam) interior which is difficult to grip with a conventional metal screw. Also, an extent of the anchor assembly 200 that remains exposed after installation can be configured to be generally without a horizontal surface, and thereby avoid collection of dust. As will be appreciated, exposed horizontal surfaces, such as those found in conventional wall mounting assemblies, can harbor contaminants including filth and mildew, as they tend to collect dust and debris along with water from wash downs.

In some embodiments, the areas of the anchor assembly 200 that remain exposed after installation are further configured to repel contaminants and to be easy to inspect and clean. For example, one or more of the exposed surfaces included in the external assembly 206 may be made with stainless steel and polished to a #4 sanitary finish, or the like. As another example, the portions of the external assembly 206 may be configured to create a tight seal with the thin panel 116, so as to prevent the formation of small gaps between the wall structure 102 and the anchor assembly 200. It should be appreciated that small gaps or crevices, such as those found in conventional anchor assemblies, can be difficult to inspect and clean or allow water or cleaning solution to pass into the mounting area of the assembly and/or the opening in the wall panel that is needed for mounting. At the same time, the anchor assembly 200 may be configured to hold the supported element (e.g., strut member) a predetermined distance away from the wall (see, e.g., FIG. 1), with the predetermined distance being selected so that contaminants can easily fall downwards in the gap formed between the wall and the strut member.

These and other advantages of the anchor assembly 200 will become apparent based on the disclosure provided herein.

Referring back to FIG. 2, the separate components of the wall mounting assembly 100 will now be described in more detail, with additional reference to FIG. 1 as well. The anchor assembly 200 includes the internal assembly 204, which is configured to engage the internal thickness 114 of the wall structure 102 shown in FIG. 1 and reside substantially within the internal thickness 114, as well as the external assembly 206, which is configured to engage the thin panel 116 and a portion of the internal assembly 204, while residing substantially outside the wall structure 102. The anchor assembly 200 also includes the elongated fastener 202 configured to secure the external assembly 206 to the internal assembly 204 by extending through an open center of the external assembly 206 and into an internal passageway of the internal assembly 204. In embodiments, the internal assembly 204 is configured to provide good tensile strength against the wall structure 102, while the external assembly 206 is configured to provide good shear strength against the wall structure 102. This combination enables the anchor assembly 200, as a whole, to remain securely coupled to a wall structure while carrying both tension and shear loads.

In embodiments, the internal assembly 204 comprises a central anchor 210 configured for insertion into the internal thickness 114 of the wall structure 102. The internal assembly 204 further comprises a plurality of lateral anchors 212 configured for insertion into the internal thickness 114 of the wall structure 102 at an oblique angle relative to a central axis 213 of the central anchor 210. The oblique angle can be selected to evenly distribute any tension loads experienced by the wall mounting assembly 100 amongst the multiple lateral anchors 212, thus firmly securing the internal assembly 204 within the wall structure 102. The internal assembly 204 further comprises a bracket 214, a plurality of lateral fasteners 216, and an upper crown 217, as will be described in more detail below.

In embodiments, the external assembly 206 comprises a washer assembly 218 configured to create a tight seal with the thin panel 116 of the wall structure 102 and a spacer 219 configured to create sufficient space between the wall structure 102 and the support element, as shown. In addition, the washer assembly 218 and the spacer 219 may be configured to have curved or non-planar surfaces, to prevent collection of debris on exposed surfaces of the external assembly 206. In certain embodiments, the external assembly 206 and the elongated fastener 202 may be substantially similar to the external assembly and elongated fastener, respectively, shown and described in U.S. Pat. No. 11,428,255, filed on Aug. 30, 2022 and entitled “Wall Mounting Assembly,” which has the same inventor as the present disclosure and is incorporated by reference herein in its entirety.

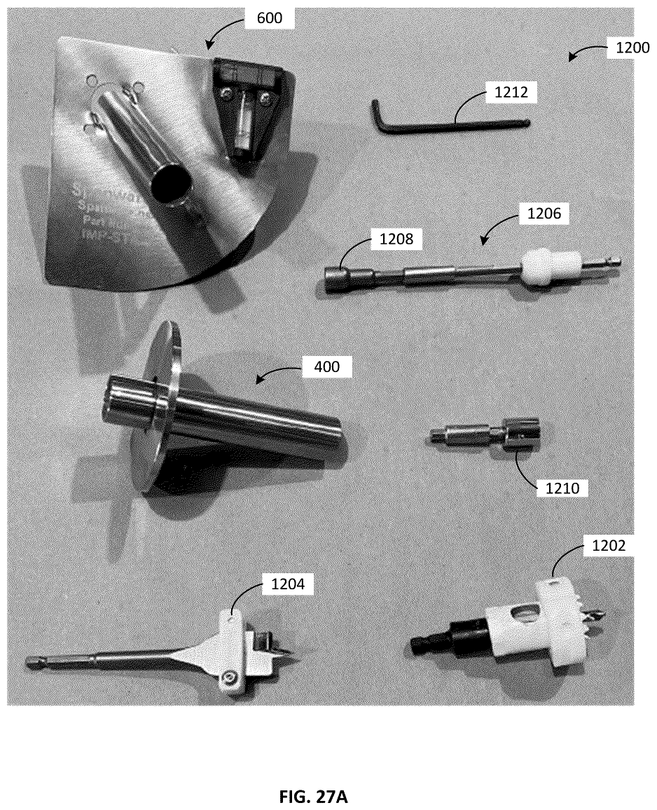

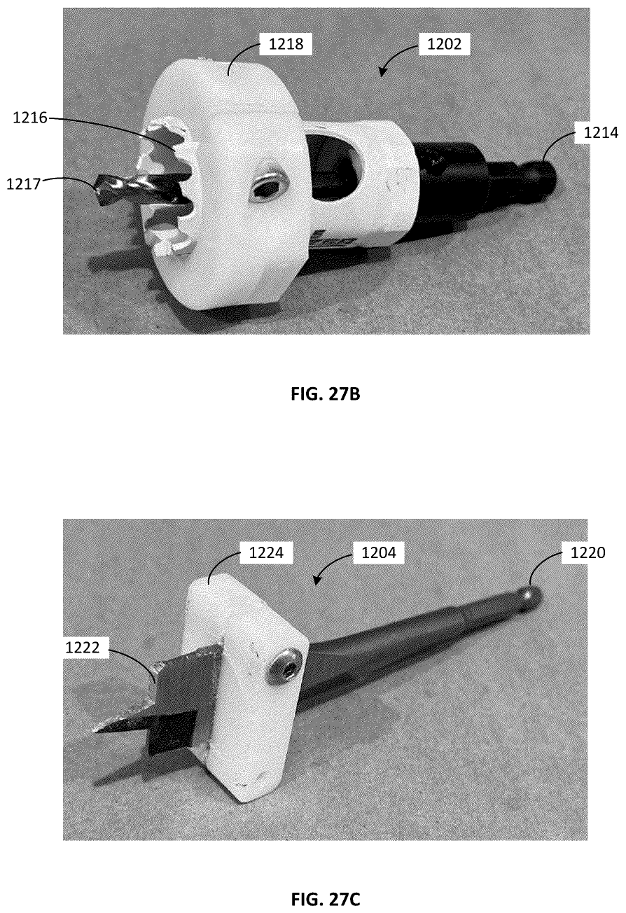

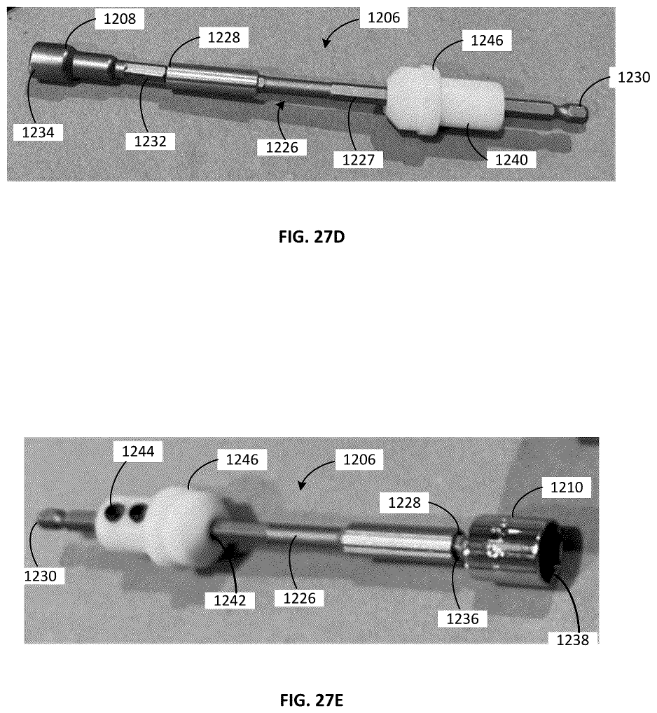

Certain embodiments of the present disclosure include an installation system comprising a first installation tool 400 (also referred to herein as the “central installation tool”) for installing the central anchor 210 of the anchor assembly 200 into the wall structure 102 and a second installation tool 600 (also referred to herein as the “angled installation tool”) for installing one or more lateral anchors 212 of the anchor assembly 200 into the wall structure 102, for example, as shown in FIG. 1. In particular, the installation system may be configured to facilitate installation of each anchor of the anchor assembly 200 at the intended and accurate angle, as described herein. In some embodiments, the installation system may be provided as part of a kit, for example, as shown in FIG. 27A.

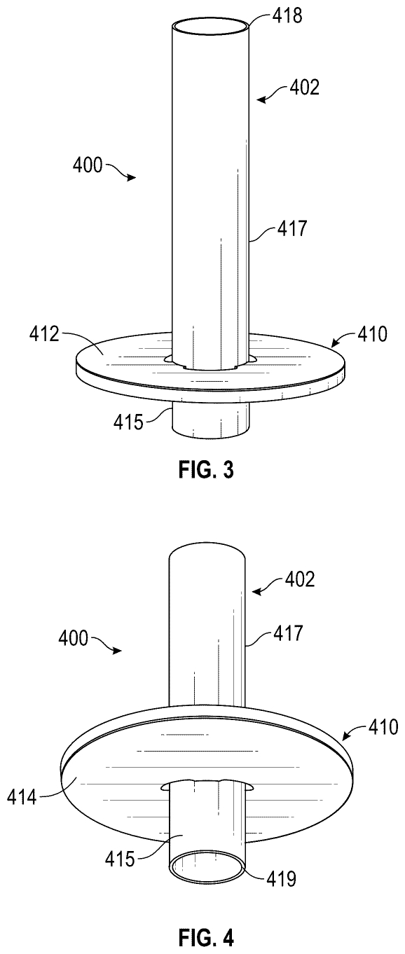

FIG. 3 is a side perspective view of the first exemplary installation tool 400 configured for installing a central anchor (e.g., central anchor 210 of FIG. 2) of an anchor assembly in a wall structure (e.g., wall structure 102 of FIG. 1), in accordance with embodiments. Referring additionally to FIG. 4, the first installation tool 400 comprises a guide 402 and an elongated plate body 410 (also referred to herein as the “plate body” or the “first plate body”) coupled to the guide 402. The plate body 410 has an upper surface 412 and an opposing, substantially flat lower surface 414 that is configured to engage the wall structure (e.g., the thin panel 116, as shown in FIG. 1) upon inserting a bottom portion 415 of the guide 402 into the installation hole 118 formed in the wall structure 102. The plate body 410 defines an opening 416. The opening 416 is suitably sized and shaped to receive the guide 402 (also referred to herein as the “first guide”), as described below.

In embodiments, the plate body 410 is suitably sized and shaped such that the lower surface 414 can engage with the wall structure and align substantially parallel to the wall structure once the bottom portion 415 of the guide 402 is inserted into the wall structure. For example, the lower surface 414 may be configured to have a diameter d that extends wide enough to span across any uneven surfaces of the wall structure during installation of the central anchor 210, as described in further detail below. In addition, the lower surface 414 may be substantially flat to better enable the plate body 410 to fully engage or contact the outer surface of the wall structure. In embodiments, the plate body 410 is substantially circular, as shown.

The guide 402 is configured to guide or steer the central anchor 210 towards the installation hole 118 in the thin panel 116 as the central anchor 210 is inserted into the wall structure 102. The guide 402 extends through the opening 416 of the plate body 410 such that the bottom portion 415 of the guide 402 extends below the plate body 410 and a top portion 417 of the guide 402 remains above the plate body 410. The top portion 417 of the guide 402 terminates at a first open end 418 of the guide 402, while the bottom portion 415 of the guide 402 terminates at a second open end 419 of the guide 402, opposite the first.

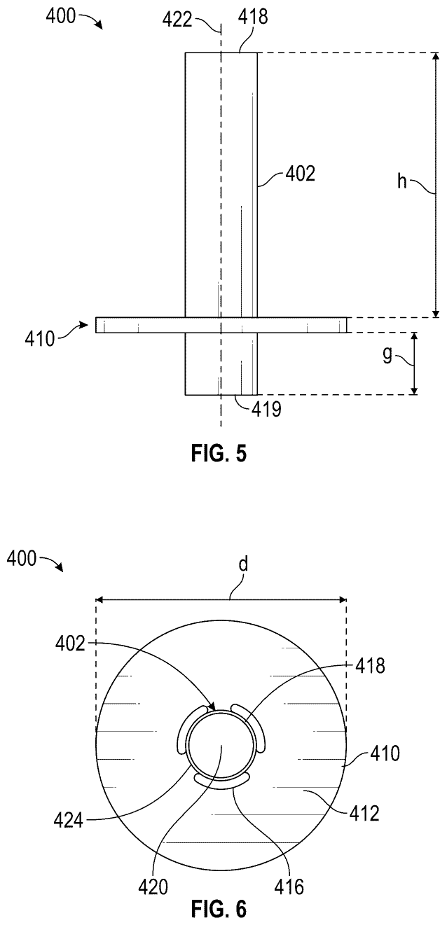

Referring additionally to FIG. 5, the first open end 418 is located a first distance h above the upper surface 412 of the plate body 410, such that the top portion 417 has a first length substantially equal to the first distance h, and the second open end 419 is located a second distance g below the lower surface 414 of the plate body 410, such that the bottom portion 404 has a second length substantially equal to the second distance g. In certain embodiments, the first distance h is greater than the second distance g. For example, the first distance may be at least twice as large as the second distance, as shown. During installation of the central anchor 210, the second distance g of the guide 402 (or the entire length of the bottom portion 415) is configured to be positioned inside the wall structure (e.g., engaging the inner portion 114) such that the lower surface 414 engages the outer portion of the wall structure (e.g., the thin panel 116).

The guide 402 defines an internal passageway 420 between the first open end 418 and the second open end 419. In certain embodiments, the internal passageway 420 is sized and shaped to receive the central anchor 210 of the anchor assembly 200 during installation of the central anchor 210. The internal passageway 420 is configured to allow the central anchor 210 to pass through the internal passageway 420 and guide the central anchor 210 into the wall structure at an intended angle. In particular, a diameter of the internal passageway 420 may be determined relative to an outer diameter of the central anchor 210 to allow passage of the central anchor 210. For example, the diameter of the internal passageway 420 may be larger than the outer diameter of the central anchor 210. In addition, the diameter of the internal passageway 420 may be configured to keep the central anchor 210 on a straight path through the internal passageway 420. For example, the diameter may be only slightly or minimally larger than the outer diameter of the central anchor 210 to ensure that the central anchor 210 remains substantially aligned with a central axis 422 of the internal passageway 420 as the central anchor 210 passes through the internal passageway 420. Moreover, in embodiments where the central anchor 210 is intended to be inserted into the wall structure at a straight angle, or substantially perpendicular to the outer surface of the wall structure, the guide 402 is coupled to the plate body 410 such that the central axis 422 of the internal passageway 420 is substantially perpendicular to the lower surface 414 of the plate body 410. In this manner, the guide 402 can be configured to ensure that the central anchor 210 travels through the internal passageway 420 in a substantially straight line, or parallel to the central axis 422, and enters the wall structure at an angle that is substantially perpendicular to the lower surface 414 of the plate body 410.

Referring additionally to FIG. 6, the plate body 410 may include at least one attachment point 424 configured to engage with the guide 402 near the opening 416. The at least one attachment point 424 may be configured to rigidly connect the plate body 410 to the guide 402. In the illustrated embodiment, the plate body 410 includes three attachment points spaced substantially equidistant about the opening 416 of the plate body 410.

In certain embodiments, the first installation tool 400 is comprised of metal (e.g., aluminum, stainless steel, etc.) or the like. In alternative embodiments, the components of the first installation tool 400 are made of differing materials and rigidly connected. The first installation tool 400 should be made of a sufficiently rigid material such that various forces applied in various directions during installation of the anchor assembly 200 do not deform the tool. For example, the first installation tool 400 should be made of material configured to withstand lateral forces and torque applied on the guide 402 such that the central axis 422 of the internal passageway 420 remains at the desired angle relative to the lower surface 414 of the plate body 410 during installation of the central anchor 210, as this angle may dictate the angle at which the central anchor 210 is installed in the wall structure.

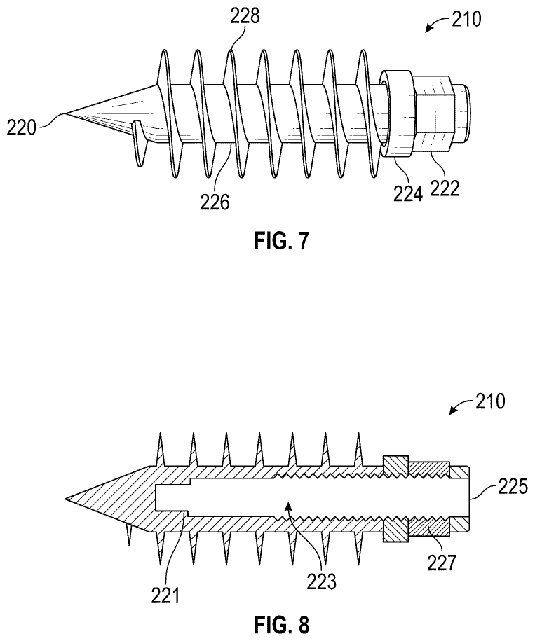

FIG. 7 is a side perspective view of an exemplary central anchor 210 with an outer wall 226 and a central passageway 223 extending between a pointed distal end 220 and an open top end 225 of the central anchor 210, in accordance with embodiments. Referring additionally to FIG. 8, the central passageway 223 comprises a female hex portion 221 and a threaded surface 227 for securely receiving the elongated fastener 202 within the central anchor 210. The outer wall 226 includes an opposing drive head 222 configured for user engagement when forcing or inserting the central anchor 210 into the inner wall portion 114 of the wall panel 102 (e.g., as shown in FIG. 1). The outer wall 226 may also include an elevated surface 224 positioned between the drive head 222 and a generally helical arrangement of helical threading 228 (also referred to herein as “helical threading”) projecting radially outwards along an extent of the outer wall 226. The elevated surface 224 may be configured to act as a stop such that when a nut driver 540 engages the drive head 222 of the central anchor 210, as further described below, an outer edge of the nut driver 540 engages an edge of the elevated surface 224 and stops at a defined distance from the helical arrangement of helical threading 228.

The diameter of the internal passageway 420 of the guide 402 of the first installation tool 400 may be determined relative to the helical arrangement of helical threading 228 (also referred to herein as “helical threading”). For example, the diameter of the internal passageway 420 may be slightly larger than the outside diameter of the helical threading 228, so that the central anchor 210 remains substantially aligned with the central axis 422 of the internal passageway 420 as the central anchor 210 passes through the internal passageway 420.

According to embodiments, the central anchor 210 can be configured to facilitate installation and/or insertion of the central anchor 210 into the wall structure 102. For example, the distal end 220 of the central anchor 210 may have a generally conical or tapered shape with a pointed and/or sharp tip to help create or bore a path through the thick foam as the central anchor 210 is inserted into the inner portion 114 of the wall structure 102 during installation.

The central anchor 210 preferably includes an extent of its length with the helical threading 228 or similar auger outer arrangement, wherein the helical threading 228 is configured to cut through the compressible (or frangible) wall material without wandering (e.g., so as to move in a steady, straight line) and/or tearing. For example, the helical threading 228 can be formed of wide walls with thin, sharp edges spiraling around the outer wall 226, the edges being configured to cut through the compressible material of the inner wall portion 114 without tearing. In addition, an overall height of the helical threading 228 at one or more locations along the outer wall 226 can be selected so the helical threading 228 has a progressive or tapered profile. For example, the progressive thread profile along an extent of the length of the central anchor 210 may be formed by gradually narrowing an overall height of the helical threading 228 as the helical threading 228 nears the distal end 220. In some embodiments, the overall profile of the central anchor 210 progressively narrows starting from the open top end 225 and ending at the distal end 220. In either case, the progressive thread profile can be configured so that the helical threading 228 gradually and steadily increase the size of the hole being formed through the compressible material as the central anchor 210 travels deeper and deeper into the inner wall portion 114.

The central anchor 210 may be comprised of food grade plastic, such as, e.g., delrin, or any other suitable material. In some embodiments, the central anchor 210 is constructed as a single or unitary piece, for example, using injection molding or other appropriate manufacturing technique, to provide increased structural integrity. Furthermore, the central anchor 210 can have a length configured to enable an extent of the outer wall 226 to be forced into and through the compressible material of the inner portion 114. In one exemplary embodiment, the central anchor 210 has an overall length of about two to three inches (e.g., approximately 2.9 inches). This length plus the use of a sturdy, lightweight material (e.g., a hard plastic) and a progressive thread profile enable the central anchor 210 to be inserted (or screwed) into the inner portion 114 of the wall structure 102 with a controlled amount of resistance and torque.

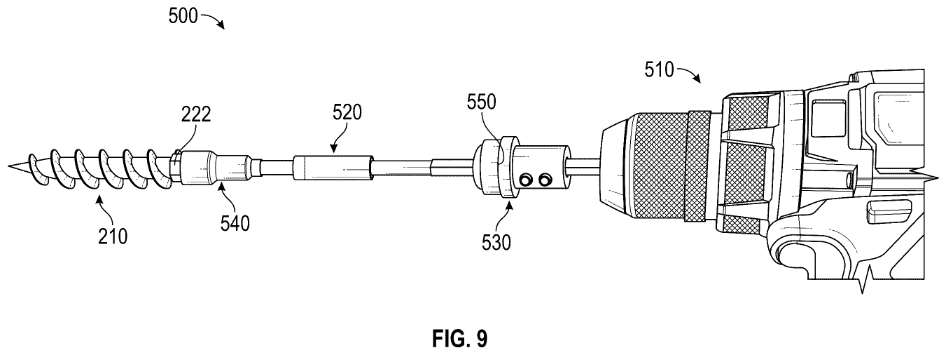

FIG. 9 is side view of the central anchor 210 attached to a driving assembly 500 for installing the central anchor 210 in the wall structure 102, in accordance with embodiments. The driving assembly 500 is coupled to a driving tool 510, which may be a drill, for example, as shown in FIG. 9, or any other suitable tool (e.g., a screw driver, etc.). The driving assembly 500 comprises a shank 520, a central drill stop 530 coupled to the shank 520, and a nut driver 540 coupled to the shank 520. The nut driver 540 (also referred to herein as a “central nut driver”) is configured to receive the drive head 222 of the central anchor 210. In embodiments, at least some of the components of the driving assembly 500 may be included in a kit for use with the first installation tool 400, for example, as shown in FIGS. 27A, 27D, and 27E and further described herein.

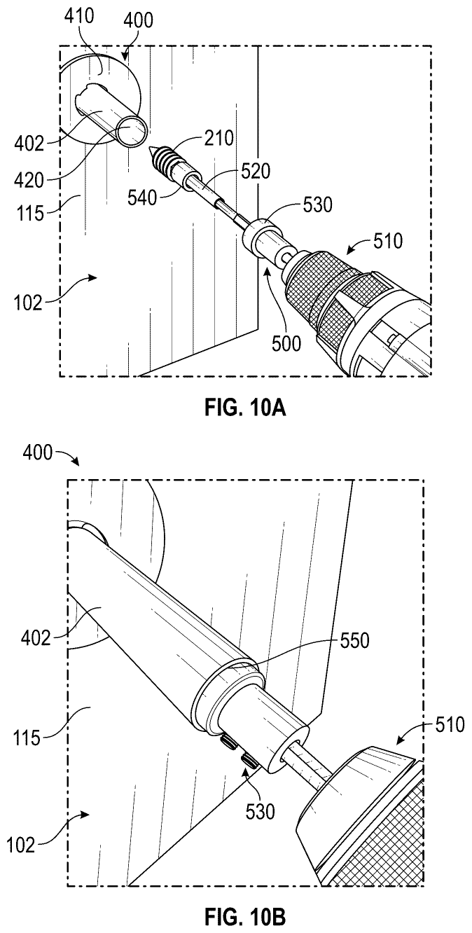

Referring additionally to FIG. 10A, the lower surface 414 of the plate body 410 of the first installation tool 400 is configured to engage with an outer side 119 of the thin panel 116 of the wall structure 102 such that the lower surface 414 and the outer side 119 of the thin panel 116 are substantially parallel. In embodiments, the lower surface 414 of the plate body 410 extends such that any imperfections or texture on the outer side 119 of the thin panel 116 does not substantially change the angle of the lower surface 414 relative to the outer side 119 of the thin panel 116.

Referring additionally to FIG. 10B, the first installation tool 400 may be a jig configured to guide the central anchor 210 while the central anchor 210 is coupled to the driving assembly 500 to install the central anchor 210 in the wall structure 102. The first installation tool 400 is configured to guide the central anchor 210 through the internal passageway 420 of the guide 402 and into the wall structure 102 such that the central anchor 210 enters and moves through wall structure 102 while remaining generally straight, or along a substantially linear path, thus avoiding excessive tearing of compressible material of the wall structure and wandering off the intended path of installment.

The central drill stop 530 is configured to stop the path of the driving tool 510 when a stop protrusion 550 of the central drill stop 530 contacts the first open end 418 of the guide 402 of the first installation tool 400, as shown in FIG. 10B. The various dimensions of the central drill stop 530, including the various dimensions of the stop protrusion 550, may depend on the dimensions of the guide 402 of the first installation tool 400. For example, in the embodiment of FIGS. 9, 10A, and 10B, the stop protrusion 550 is substantially cylindrical and an outer diameter of the stop protrusion 550 may be a larger diameter than the diameter of the internal passageway 420 of the guide 402 to prevent the stop protrusion 550 from entering the internal passageway 420 of the guide 402. In other embodiments, the stop protrusion 550 comprises a non-cylindrical shape, such as a cube or triangular prism, for example, and relevant dimensions of such shape of the stop protrusion 550 may be configured to prevent at least a portion of the stop protrusion 550 from entering the internal passageway 420. In embodiments, the longitudinal position of the central drill stop 530 along the shank 520 may also vary based on a desired installation depth of the central anchor 210 in the wall structure 102. For example, the central drill stop 530 may be positioned on the shank 520 so that the stop protrusion 550 engages the first open end 418 of the guide 402 when the central anchor 210 reaches the desired depth in the wall structure 102, as shown in FIG. 10B.

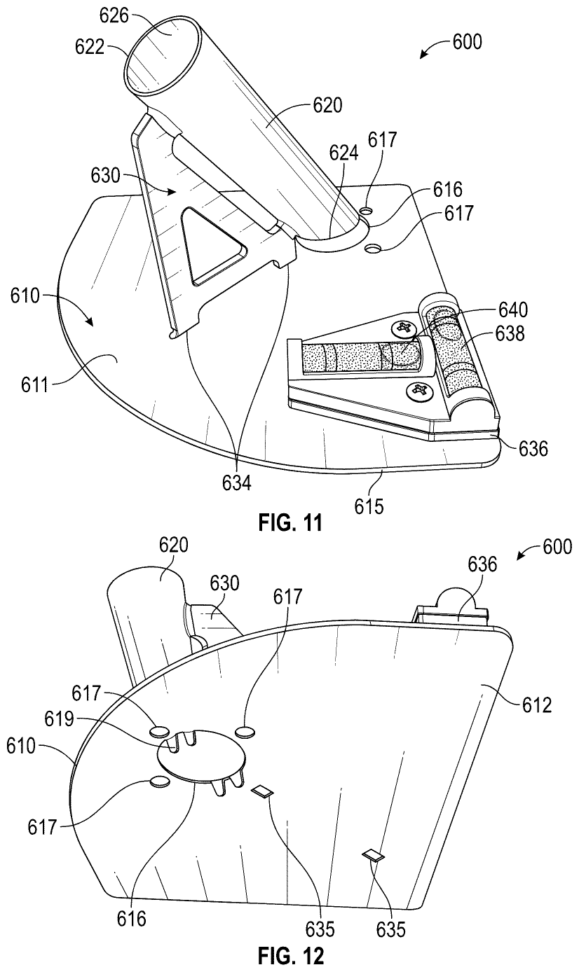

FIG. 11 is a top perspective view of the exemplary second installation tool 600 configured for installing a lateral anchor (e.g., lateral anchor 212 of FIG. 2) of an anchor assembly in a wall structure (e.g., wall structure 102 of FIG. 1), in accordance with embodiments. The second installation tool 600 comprises an elongated plate body 610 (also referred to herein as the “plate body” and the “second plate body”) with an upper surface 611 and a substantially flat lower surface 612 configured to engage the wall structure (e.g., the outer side 119 of the thin panel 116 of the wall structure 102, as shown in FIG. 1).

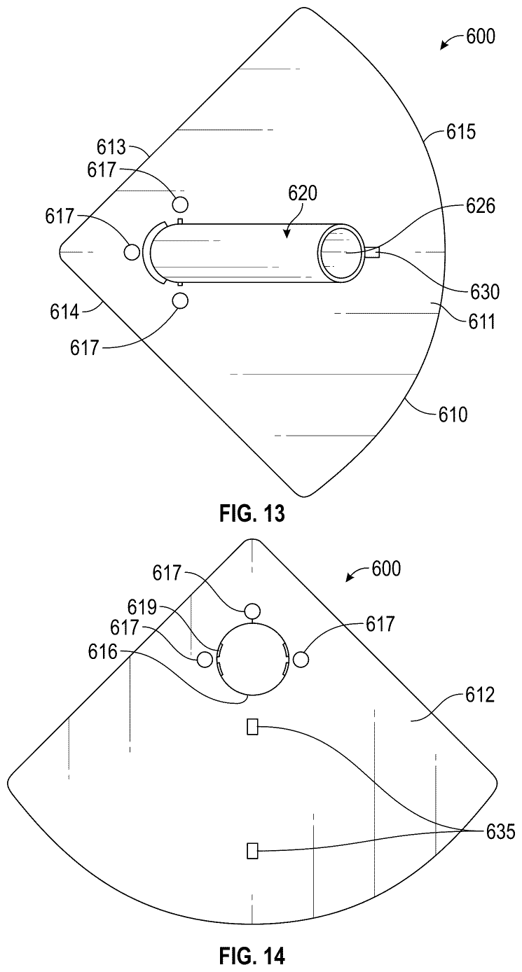

In embodiments, the lower surface 612 of the plate body 610 is suitably sized and shaped such that the lower surface 612 can engage with the outer side 119 of the thin panel 116 of the wall structure 102 and align substantially parallel to the thin panel 116. For example, the lower surface 612 of the plate body 610 may be configured to extend wide enough to span across uneven surfaces during installation of the lateral anchor 212, as described in further detail below. In addition, the lower surface 612 may be substantially flat in order to enable the plate body 610 to fully engage or contact the outer side 119 of the thin panel 116. Referring additionally to FIG. 13, the plate body 610 may include a first edge 613, a second edge 614, and a third edge 615. In embodiments, the plate body 610 is shaped as a quarter circle, with the first edge 613 extending substantially perpendicular to the second edge 614 and the third edge 615 extending curvilinearly, or having a curvilinear extent, between the first edge 613 to the second edge 614.

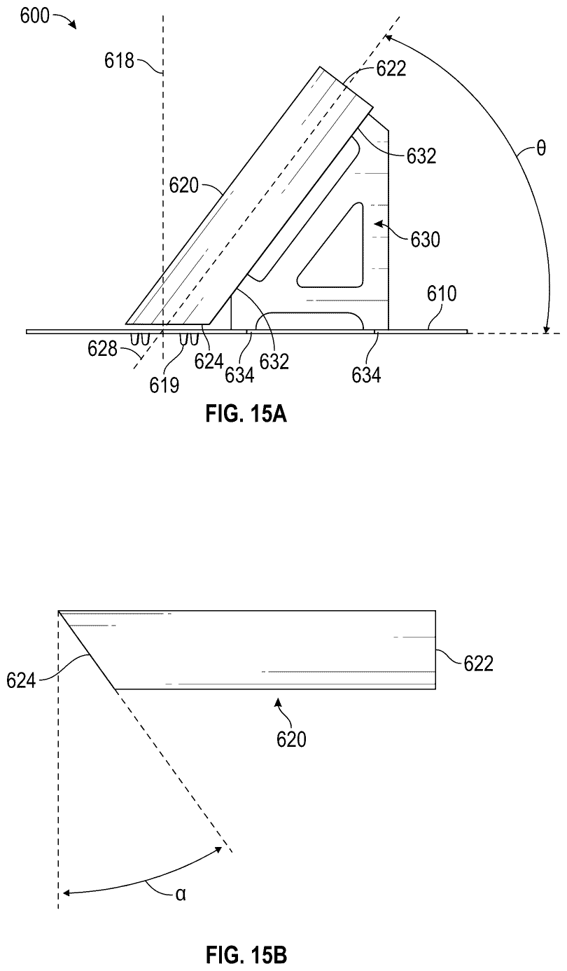

The plate body 610 defines a major hole 616 (also referred to herein as an “insertion hole”) and a plurality of minor holes 617 (also referred to herein as “alignment holes”) positioned adjacent to the insertion hole 616. Referring additionally to FIG. 15A, the insertion hole 616 has a central axis 618. Referring additionally to FIGS. 13 and 14, the plate body 610 of the exemplary embodiment defines three alignment holes 617. A first alignment hole 617 is substantially aligned with a meeting point of the first edge 613 and the second edge 614. A second alignment hole 617 is positioned approximately 90 degrees clockwise from the first alignment hole 617 relative to the central axis 618 and a third alignment hole 617 is positioned approximately 90 degrees counterclockwise from the first alignment hole 617 relative to the central axis 618. As such, the second alignment hole 617 is offset from the third alignment hole 617 by approximately 180 degrees relative to the central axis 618 of the insertion hole 616. It should be appreciated that the plurality of alignment holes 617 can consist of a number other than three (e.g., two, four, five, etc.) and the additional alignment holes 617 may be offset from the first alignment hole 617 by an angle other than 90 degrees.

The plate body 610 further comprises one or more protrusions 619 configured for insertion into the wall structure 102 (e.g., engaging the inner portion 114) during installation of the lateral anchor 212. In the illustrated embodiment, the plate body 610 comprises a first pair of protrusions 619 aligned with a first side of the insertion hole 616 and a second pair of protrusions 619 aligned with a second, opposing side of the insertion hole 616. As such, the first pair of protrusions 619 is offset from the second pair of protrusions 619 by approximately 180 degrees relative to the central axis 618 of the installment hole. It should be appreciated that the number and position of the one or more protrusions 619 can vary. For example, in other embodiments, the plate body 610 may include a single protrusion 619 on each side of the insertion hole 616, instead of the pairs of protrusions 619 shown in the illustrated embodiment. In certain embodiments the one or more protrusions 619 and the plate body 610 may be formed of the same piece of material (e.g., a sheet of metal such as stainless steel) such that, during production, the one or more protrusions 619 may initially extend in the same plane as the plate body 610 and, during assembly, may be folded to a desired angle, such as, e.g., substantially perpendicular to the lower surface 612 of the plate body 610, as shown in FIGS. 12 and 14.

Referring now to FIGS. 15A and 15B, the second installation tool 600 further comprises a guide 620 configured to guide or steer the lateral anchor 212 into the installation hole 118 in the thin panel 116 at an intended angle and maintain that angle as the lateral anchor 212 is fully inserted into the wall structure 102. As shown in FIG. 15A, the guide 620 (also referred to herein as the “second guide”) is coupled to the plate body 610 at an angle configured to ensure installation of the lateral anchor 212 at the intended angle. In particular, the guide 620 includes a first open end 622 and a second open end 624 positioned adjacent to the insertion hole 616. The second open end 624 is angled or slanted relative to the first open end 622 to facilitate or create the angled attachment of the guide 620 to the plate body 610. For example, the second open end 624 may extend at an angle a relative to the first open end 622, as shown in FIG. 15B. In embodiments, the angle a may be approximately 37 degrees.

The guide 620 defines an internal passageway 626 between the first open end 622 and the second open end 624. In embodiments, the internal passageway 626 is sized and shaped to receive the lateral anchor 212 and allow passage of the lateral anchor 212 through the guide 620 during installation of the lateral anchor 212 into the wall structure. For example, the diameter of the internal passageway 626 may be determined relative to an outer diameter of the lateral anchor 212. In certain embodiments, the diameter of the internal passageway 626 may be configured to be slightly larger than the outer diameter of the lateral anchor 212, so that the lateral anchor 212 remains substantially aligned with a central axis 628 of the internal passageway 626 as the lateral anchor 212 passes though the internal passageway 626.

The internal passageway 626 is also configured to ensure that the lateral anchor 212 is inserted into the wall structure at the correct or intended angle. In embodiments, the central axis 628 of the internal passageway 626 is configured to extend at an oblique angle θ relative to the lower surface 612 of the plate body 610. As the lateral anchor 212 passes through the internal passageway 626, the internal walls of the guide 620 cause the lateral anchor 212 to maintain travel in the direction of the oblique angle θ, which ensures that the lateral anchor 212 also enters the wall structure 102 at approximately the same angle relative to the lower surface 612 of the plate body 610. The oblique angle θ can be selected to evenly distribute any tension loads experienced by the wall mounting assembly 100 amongst the plurality of lateral anchors 212, thus firmly securing the internal assembly 204 within the wall structure 102. In certain embodiments, the oblique angle θ is approximately 53 degrees.

The second installation tool 600 further comprises a support 630 configured to fixedly attach the guide 620 to the upper surface 611 of the plate body 610. The support 630 may comprise at least one attachment point 632 to the guide 620. The at least one attachment point 632 to the guide 620 is configured to rigidly attach the support 630 to the guide 620. The support 630 may additionally comprise at least one attachment point 634 to the plate body 610. The at least one attachment point 634 to the plate body 610 is configured to rigidly attach the support 630 to the plate body 610. Referring to FIG. 15A, the illustrated embodiment of the support 630 includes two attachment points 632 to the guide 620 and two attachment points 634 to the plate body 610. However, it should be appreciated that the at least one attachment points 632 and 634 can consist of any number and configuration. Referring additionally to FIG. 14, certain embodiments of the plate body 610 define at least one seating aperture 635 to facilitate attachment of the support 630 to the plate body 610.

Referring back to FIG. 11, the second installation tool 600 may further comprise a mounting area 636 coupled to the upper surface 611 of the plate body 610 and configured to receive one or more leveling devices, or level assembly. The level assembly may be configured to identify a level position of the plate body 610 along one or more axes of the lower surface of plate body 610, or otherwise help align the installation tool 600 with the wall structure during installation of the anchor assembly. In the illustrated embodiment, the second installation tool 600 comprises a first leveling device 638 fixedly attached to the upper surface 611 of the plate body 610, or the mounting area 636 located therein. As shown, the first leveling device 638 may be aligned with the first edge 613 of the plate body 610 and configured to extend longitudinally in the horizontal direction. The second installation tool 600 may further comprise a second leveling device 640 fixedly attached to the upper surface 611 of the plate body 610, or the mounting area 636 located therein. As shown, the second leveling device 640 may be aligned with the second edge 614 of the plate body 610 and configured to extend longitudinally in the vertical direction. In other embodiments, the second installation tool 600 may comprise a dual-axis level assembly, a precision level assembly comprising multiple leveling devices positioned on different axes, or any other suitable level for facilitating alignment of the second installation tool 600 against the wall structure.

In certain embodiments, the second installation tool 600 is comprised of metal (e.g., aluminum, stainless steel, etc.) or the like. In alternative embodiments, the components of the second installation tool 600 are made of differing materials and rigidly connected. The second installation tool 600 should be made of a sufficiently rigid material such that various forces applied in various directions during installation of the anchor assembly 200 do not deform the tool. For example, the second installation tool 600 should be made of material configured to withstand lateral forces and torque applied on the guide 620 such that the central axis 628 of the guide 620 remains at the desired angle relative to the lower surface 612 of the plate body 610 during installation of each lateral anchor 212, as this angle dictates the angle at which each lateral anchor 212 is installed in the wall structure.

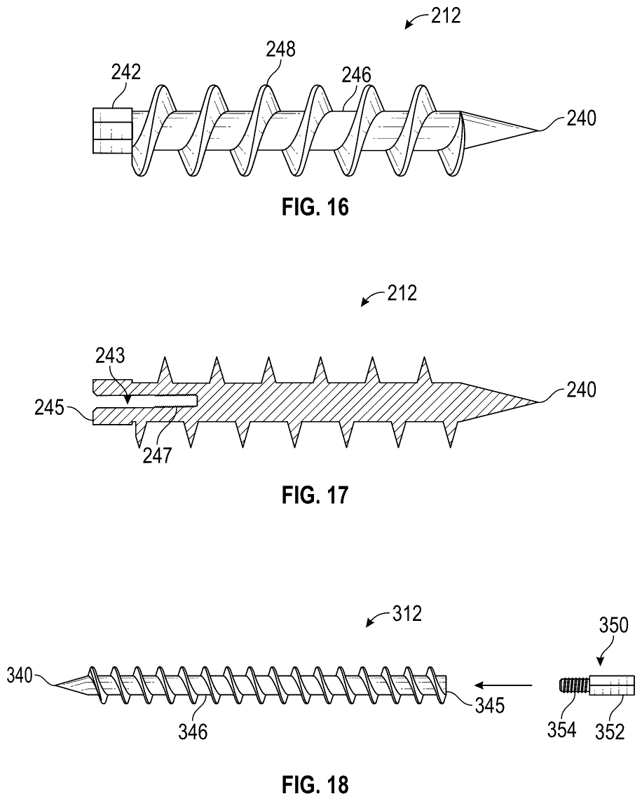

FIG. 16 is a side view of an exemplary lateral anchor 212 with an outer wall 246 having a generally helical arrangement of threads 248 (also referred to herein as “helical threading”) projecting radially outwards along an extent of the outer wall 246, in accordance with embodiments. The diameter of the internal passageway 626 of the guide 620 of the second installation tool may be determined relative to the helical arrangement of threads 248. For example, the diameter of the internal passageway 626 may be slightly larger than the outside diameter of the threads 248, so that the lateral anchor 212 remains substantially aligned with the central axis 628 of the internal passageway 626 as the lateral anchor 212 passes through the internal passageway 626. The outer wall 246 additionally includes an opposing drive head 242 configured for user engagement when forcing or inserting the lateral anchor 212 into the inner wall portion 114 of the wall panel 102 (e.g., as shown in FIG. 1).

Referring additionally to FIG. 17, the lateral anchor 212 includes a central passageway 243 extending between a pointed distal end 240 and an open top end 245 of the lateral anchor 212 and comprising a threaded surface 247 for securely receiving a lateral fastener 216 within the lateral anchor 212.

According to embodiments, the lateral anchor 212 can be configured to facilitate installation and/or insertion of the lateral anchor 212 into the wall structure 102. For example, the distal end 240 of the lateral anchor 212 may have a generally conical or tapered shape with a pointed and/or sharp tip to help create or bore a path through the thick foam as the lateral anchor 212 is inserted into the inner portion 114 of the wall structure 102 during installation.

The lateral anchor 212 preferably includes an extent of its length with helical threading 248 or similar auger outer arrangement, wherein the helical threading 248 is configured to cut through the compressible (or frangible) wall material without wandering (e.g., so as to move in a steady, straight line) and/or tearing. For example, the helical threading 248 can be formed of wide walls with thin, sharp edges spiraling around the outer wall 246, the edges being configured to cut through the compressible material of the inner wall portion 114 without tearing. In addition, an overall height of the helical threading 248 at one or more locations along the outer wall 246 can be selected so the threads 248 have a progressive or tapered profile. For example, the progressive thread profile along an extent of the length of the lateral anchor 212 may be formed by gradually narrowing an overall height of the helical threading 248 as the threads 248 near the distal end 240. In some embodiments, the overall profile of the lateral anchor 212 progressively narrows starting from the open top end 245 and ending at the distal end 240. In either case, the progressive thread profile can be configured so that the helical threading 248 gradually and steadily increase the size of the hole being formed through the compressible material as the lateral anchor 212 travels deeper and deeper into the inner wall portion 114.

The lateral anchor 212 may be comprised of food grade plastic, such as, e.g., delrin, or any other suitable material. In some embodiments, the lateral anchor 212 is constructed as a single or unitary piece, for example, using injection molding or other appropriate manufacturing technique, to provide increased structural integrity. The use of a sturdy, lightweight material (e.g., a hard plastic) and a progressive thread profile enable the lateral anchor 212 to be inserted, or screwed, into the inner portion 114 of the wall structure 102 with a controlled amount of resistance and torque.

In embodiments, a length of each of the lateral anchors 212 may be selected based on a thickness or depth of the wall structure 102, which can vary depending on the application (e.g., 3 in., 4 in., 5 in., 6 in., etc.). The length of the lateral anchor 212 can affect the load carrying capability of the lateral anchor 212. Accordingly, in some cases, the length may be selected so that the lateral anchors 212 can angularly extend as far as possible into the internal thickness 114, for example, without penetrating an opposite or back side of the wall structure 102 (i.e. opposite the thin panel 116). In one example embodiment, each lateral anchor 212 is about 3 to 4 inches long.

FIG. 18 is a side view of another exemplary lateral anchor 312 and adapter 350 configured to allow a user to select the length of the lateral anchor 312, in accordance with embodiments. The lateral anchor 312 includes an outer wall 346 that is configured to be cut to a desired length to create an open top end 345 opposite a pointed distal end 340. The lateral anchor 312 also includes a central passageway (not shown) comprising a threaded surface (not shown) for securely receiving the adapter 350 within the lateral anchor 312. In one exemplary embodiment, the uncut lateral anchor 312 has an overall length of about 8 to 9 inches (e.g., approximately 8.9 inches).

The adapter 350 includes a drive head 352 configured for user engagement when forcing or inserting the lateral anchor 312 into the inner wall portion 114 of the wall panel 102 and a threaded portion 354 configured to be received by the central passageway of the lateral anchor 312. The adapter defines a channel (not shown) comprising a threaded surface (not shown) for securely receiving one of the lateral fasteners 216 within the lateral anchor 312. In certain embodiments, the adapter 350 is comprised of substantially the same material as the lateral anchor 312 (e.g., a hard plastic) and is monolithically formed. In alternative embodiments, the threaded portion 354 may be comprised of an alternative material such as metal (e.g., aluminum, stainless steel, etc.) to facilitate a smaller thread pitch.

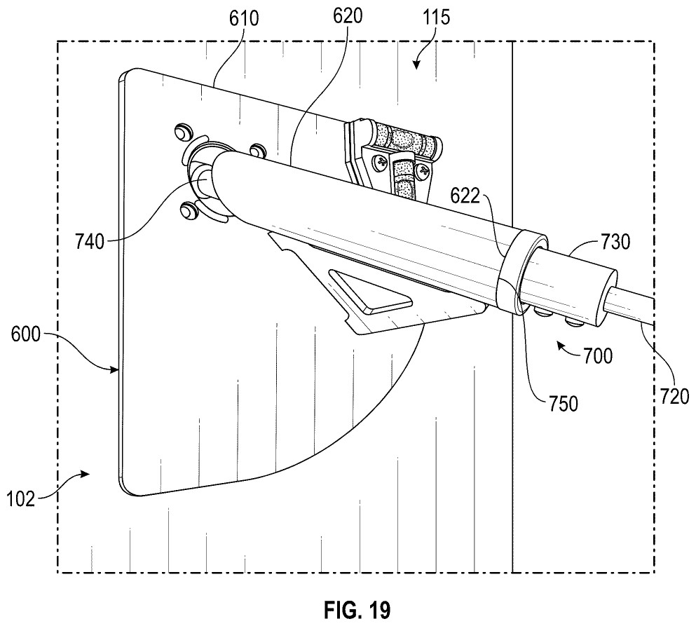

FIG. 19 depicts an exemplary use of the second installation tool 600 while inserting the lateral anchor 212 in the wall structure 102, in accordance with embodiments. The lateral anchor 212 may be coupled to a driving assembly 700 for installing the lateral anchor 212 in the wall structure 102 using a driving tool (not shown). The driving tool may be, for example, a drill (e.g., similar to the driving tool 510 shown in FIG. 9), a screwdriver, or any other suitable tool. The driving assembly 700 comprises a shank 720, a lateral drill stop 730 coupled to the shank 720, and a lateral nut driver 740 coupled to the shank 720. The lateral nut driver 740 is configured to receive the drive head 242 of the lateral anchor 212. In embodiments, the driving assembly 700 may be similar to the driving assembly 500 and in some embodiments, may include one or more of the same components as the driving assembly 500. For example, the shank 720 may be substantially similar to, or same as the shank 520 shown in FIG. 9. Also, the lateral nut driver 740 may be substantially similar to the lateral nut driver 1208 shown in FIG. 27D. In embodiments, at least some of the components of the driving assembly 700 may be included in a kit that is provided separately from the second installation tool 600, for example, as shown in FIGS. 27A, 27D, and 27E and further described herein.

Referring back to FIG. 19, the lower surface 612 of the plate body 610 of the second installation tool 600 is configured to engage the outer side 119 of the thin panel 116 of the wall structure 102 such that the substantially flat lower surface 612 and the outer side 119 of the thin panel 116 are substantially parallel. In embodiments, the lower surface 612 of the plate body 610 extends radially, longitudinally, or vertically such that any imperfections or texture on the outer side 119 of the thin panel 116 do not substantially change the angle of the flat lower surface 612 relative to the outer side 119 of the thin panel 116.

The second installation tool 600 may be a jig configured to guide the lateral anchor 212 while the lateral anchor 212 is coupled to the driving assembly 700 to install the lateral anchor 212 in the wall structure 102. The second installation tool 600 is configured to guide the lateral anchor 212 through the internal passageway of the guide 620 and into the wall structure 102, so that the lateral anchor 212 enters and moves through wall structure 102 in a generally straight direction, or along a substantially linear path, thus avoiding excessive tearing of compressible material of the wall structure or wandering off the intended angle of installment. The actual angle of installment for each of the plurality of lateral anchors 212 must be the same as the intended angle of installment to facilitate an equal distribution of tension loads among the plurality of lateral anchors 212. Additionally, the respective positions of each of the plurality of lateral anchors 212 in the wall structure 102 is designed such that the anchor assembly 200 is vectored against pullout from the wall panel 102 when under load. These features configure the anchor assembly 200 to withstand multi-vectored loading.

Additionally, the actual angle of installment of each of the plurality of lateral anchors 212 must be the same as the intended angle of installment to facilitate proper assembly and alignment of all components of the anchor assembly 200 within the wall structure. For example, the anchor assembly 200 may have strict tolerances and reduced clearance between its components that require careful adherence to avoid undesirable overlaps or run-ins within the wall structure. As such, during installation, each lateral anchor 212 must be installed in the wall accurately and at the intended angle to ensure alignment of the components of the anchor assembly as designed, and thereby ensure that the anchor assembly can be properly put together and used. For example, in embodiments, the central passageway 243 of each lateral anchor 212 must be positioned such that a plurality of apertures 258 of the bracket 214 align with the central passageway 243 of each lateral anchor 212 to allow a lateral fastener 216 to pass through the aperture 258 and be received by the central passageway 243 of each lateral anchor 212.

Referring back to FIG. 19, the lateral drill stop 730 is configured to stop the path of the driving tool when a stop protrusion 750 contacts the first open end 622 of the guide 620 of the second installation tool 600. The various dimensions of the lateral drill stop 730, including the various dimensions of the stop protrusion 750, may depend on the dimensions of the guide 620 of the second installation tool 600. For example, in the illustrated embodiment, the stop protrusion 750 is substantially cylindrical and an outer diameter of the stop protrusion 750 may be a larger diameter than the diameter of an internal passageway 626 of the guide 620 such that the stop protrusion 750 cannot enter the internal passageway 626. In alternative embodiments, the stop protrusion 750 comprises a non-cylindrical shape such as a cube or triangular prism, and relevant dimensions of the stop protrusion 750 may be configured such that a portion of the stop protrusion 750 obstructs the stop protrusion 750 from entering the internal passageway 626. The longitudinal position of the lateral drill stop 730 along the shank 720 may be determined based on the desired installation depth of the lateral anchor 212 in the wall structure 102 such that the stop protrusion 750 engages the first open end 622 of the guide 620 when the lateral anchor 212 reaches the desired depth in the wall structure 102, as shown in FIG. 19.

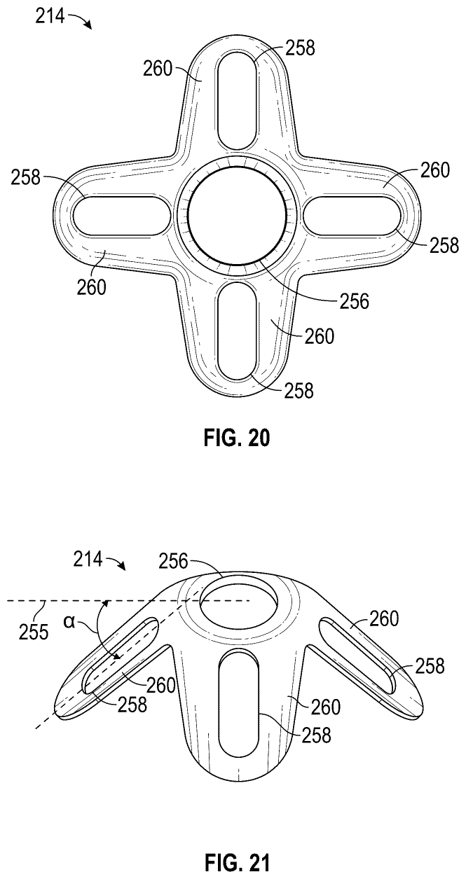

FIG. 20 is a top view of the bracket 214 of the anchor assembly 200, in accordance with certain embodiments. The exemplary bracket 214 is configured to couple to the plurality of lateral anchors 212. The bracket 214 may be configured to engage with the central anchor 210 and the upper crown 217. As an example, the bracket 214 may be made of metal (e.g., stainless steel) or any other suitable material.

Referring additionally to FIG. 21, the bracket 214 defines a central hole 256 configured to align with the central passageway 223 of the central anchor 210 and allow the elongated fastener 202 to pass through. The bracket 214 also defines a plurality of apertures 258 disposed radially around the central hole 256 at equal intervals. The apertures 258 may be configured to align with the central passageway 243 of a given lateral anchor 212 to allow a lateral fastener 216 to pass through the aperture 258 and be received by the central passageway 243 of the lateral anchor 212. As shown, in order to ensure said alignment, the bracket 214 comprises a plurality of angled walls 260 configured to extend at an angle a relative to a central horizontal axis 255 of the bracket 214. In certain embodiments, the angle a is configured to extend substantially perpendicular to the oblique angle θ of the central axis 628 of the internal passageway 626 relative to the lower surface 612 of the plate body 610, so that the angled wall 260 extends substantially parallel to the open top end 245 of the lateral anchor 212. In embodiments, each angled wall 260 comprises a respective one of the apertures 258 and the number of angled walls corresponds to the number of lateral anchors 212. As an example, each angled wall 260 may be disposed at an angle of about 37 degrees relative to a central horizontal axis 255 of the bracket 214 and may be positioned at 90 degrees intervals relative to a center of the central hole 256. While the illustrated embodiment shows four angled walls 260, the exact number of angled walls 260 may vary depending on the number of lateral anchors 212.

A plurality of lateral fasteners 216 are each configured to pass through an aperture 258 of the bracket 214 and be received by a central passageway 243 of a lateral anchor 212. In embodiments, an overall length of lateral fasteners 216 is selected so that, upon assembly, each lateral fastener 216 extends through the aperture 258 of the bracket 214 and into the central passageway 243 of the lateral anchor 212, leaving only a head of the lateral fastener 216 exposed or visible. In embodiments, the lateral fasteners 216 may be a commercially available metal bolt or screw, such as, for example, a hex bolt, a cap screw, a lag bolt, a button head bolt, a pan head bolt, or any other suitable style or type of fastener. The exact size or dimensions (e.g., body length, head diameter, etc.) of the lateral fasteners 216 may be selected based on one or more dimensions of the lateral anchor 212, the bracket 214, the upper crown 217 and/or other components of the anchor assembly 200. As an example, the head of the lateral fasteners 216 may be a rounded head with a torx drive, and the lateral fasteners 216 may have a diameter of 1/16 inch, ⅛ inch, 3/16 inch (or similar metric sizes), and the length of the lateral fasteners 216 may be ½ inch, ⅝ inch, ¾ inch, etc. In the illustrated embodiment, the lateral fastener 216 may be a No. 6 18-8 stainless steel screw with a T15 Torx drive, a 0.27 inch diameter head, a body length of ⅝ inches, and right hand threads.

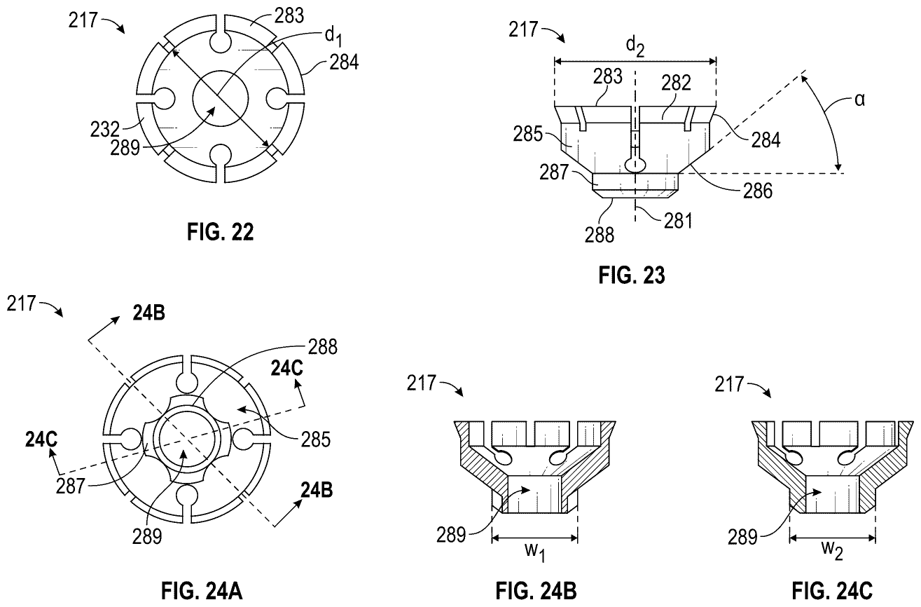

FIG. 22 is a top view of an exemplary annular collar or upper crown 217 configured to be annularly arranged at or about a central hole 256 of the bracket 214 to allow the elongated fastener 202 to pass through. The upper crown 217 is configured to engage the thin panel 116 adjacent the opening 118 upon coupling the anchor assembly 200 to the wall structure 102.

Referring additionally to FIG. 23, the upper crown 217 comprises a plurality of circumferentially spaced crown elements 282 (e.g., fingers) that cooperate to form an outer crown diameter d2 and give the crown 217 a generally castled shape. The crown elements 282 extend upwards from an upper portion 285 of the crown 217. The upper portion 285 extends upward from a lower portion 287 having a lower edge 288. An extent of each crown element 282 also extends radially outward from a central axis 281 of the upper portion 285, so as to create an outwardly sloping wall around at least a portion of the crown 217. The extent of the crown elements 282 that slope or extend radially outwards can vary.

For example, in some embodiments, each crown element 282 ends at a substantially flat top rim 283 that is formed by a flange or protruding lip portion 284 extending radially outward from the rest of the crown element 282. In such cases, the outwardly sloping wall includes the sidewall that forms the protruding lip portion 284. In the exemplary embodiment of FIGS. 23 and 24, the upwardly extending base portion 825 also extend radially outwards to form an outwardly sloping wall 286. In another embodiment, base portion 825 extends upward from, and generally perpendicular to, the base of the crown, so as to form a substantially straight crown wall. In such cases, only the protruding lip at the top rim of the crown elements forms the outwardly sloping crown wall. In yet another embodiment, the crown elements do not include the protruding lip, but an entire length of each crown element extends upwards and radially outwards from the base portion of the crown to form the outwardly sloping crown wall.

Referring back to FIGS. 22 and 23, the top rim 283 has an inner diameter di formed by the walls of the crown elements 282 and an outer diameter d2 formed by the protruding lip portion 284. In embodiments, the crown elements 282 are configured to move radially outward or radially inward in response to certain forces applied to the crown elements 282. These movements cause both the inner crown diameter di and the outer crown diameter d2 of the top rim 283 to be enlarged or reduced, respectively. In certain embodiments, the crown elements 282 include strain relief apertures configured to reduce strain on the upper crown 217.

In embodiments, the individual crown elements 282 move or deform in response to one or more forces applied to the crown 217 during installation of the anchor assembly 200, specifically during and after the crown 217 is installed in the wall structure 102. For example, in some embodiments, the crown elements 282 may be at least slightly compressed inwards as the upper crown 217 passes through the opening 118 formed in the thin panel 116 to receive the anchor assembly 200. The compression of the crown elements 282 can be caused by, for example, selection of an opening size that is smaller than a diameter of the crown 217 (such as, e.g., the outer crown diameter d2), such that the outwardly extending protruding lip portion 284 is pressed inwards by the walls of the opening 118 as the crown 217 passes there through. As another example, the crown elements 282 may be expanded outward as a projection of the washer assembly 218 engages the crown elements 282 upon coupling external assembly 206 to the internal assembly 204, as described in more detail below. The expansion of the crown elements 282 can be caused by, for example, the size and shape of the washer projection as compared to the top rim 283.

Referring now to FIGS. 24A, 24B, and 24C, the lower portion 287 and a portion of the upper portion 285 defines a central aperture 289 configured to align with the central hole 256 of the bracket 214 and allow the elongated fastener 202 to pass through. In embodiments, the lower portion 287 of the crown 217 may be sized and shaped such that the lower edge 288 may engage with a top surface of the bracket 214 while remaining surfaces of the lower portion 287 do not engage the plurality of lateral fasteners 216. For example, as shown in FIGS. 24A, 24B, and 24C, the width of the lower portion 287 may vary at differing positions around the central aperture 289. In this exemplary embodiment, the width of the lower portion 287 of the crown along section line 24B-24B is w₁ while the width of the lower portion 287 of the crown along section line 24C-24C is w₂. As another example, the surface may have a constant width, such as w₁, configured to avoid engagement of the lower portion 287 and the lateral fasteners 216. In alternative embodiments, the lower portion 287 of the crown 217 may be sized and shaped such that the lower edge 288 may engage with a top surface of the bracket 214 and the remaining surfaces of the lower portion 287 engage the plurality of lateral fasteners 216.

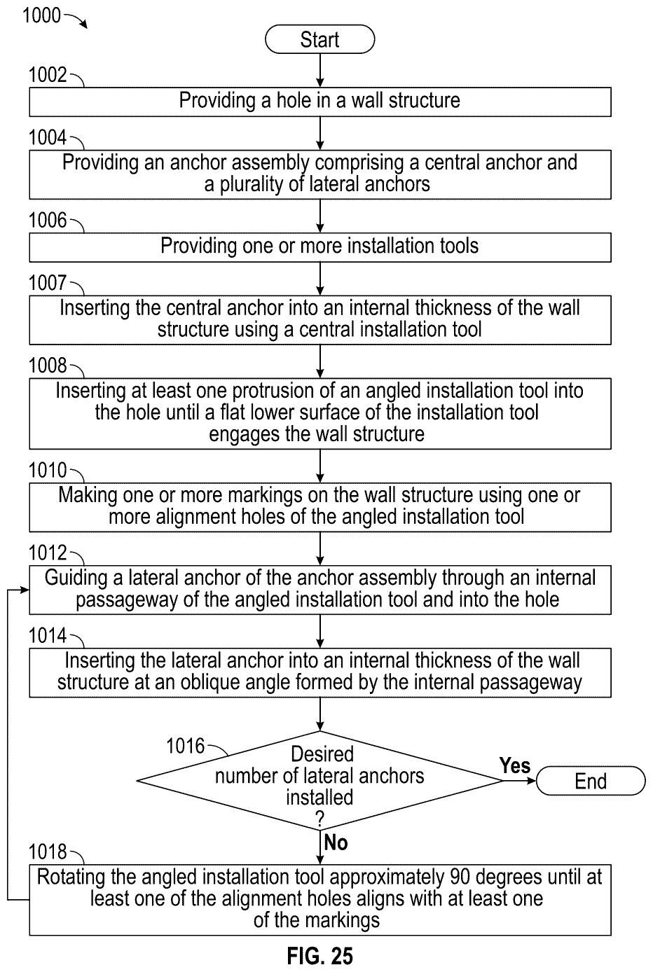

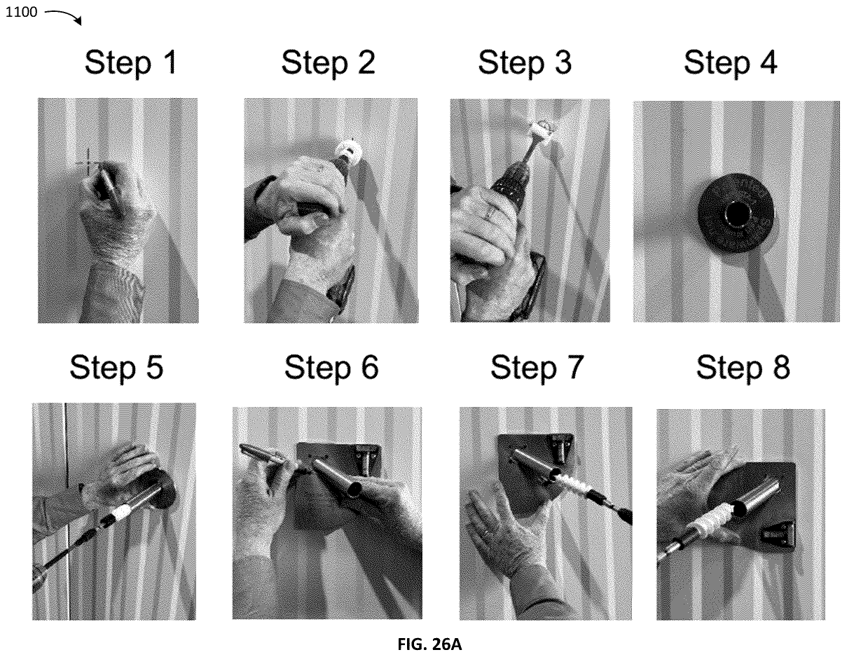

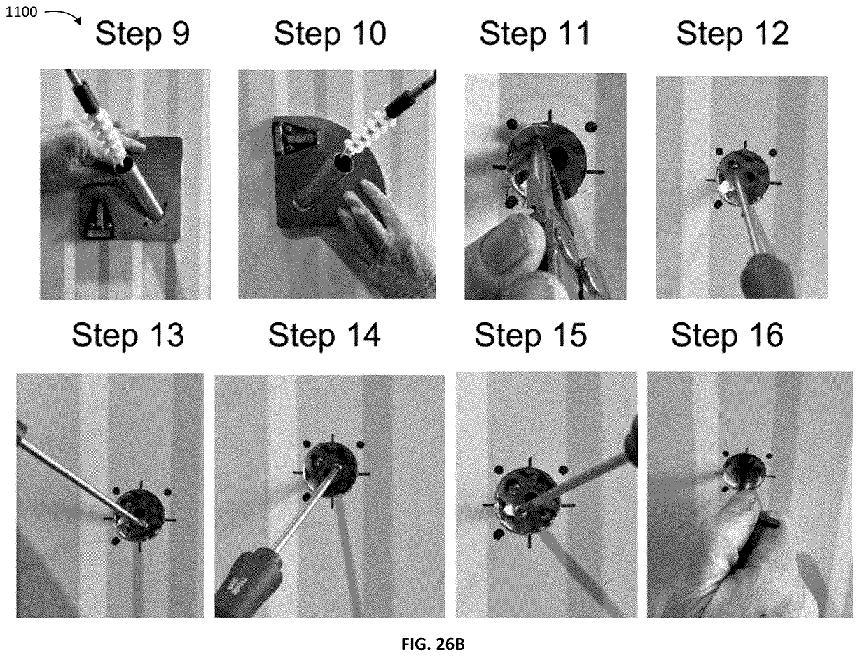

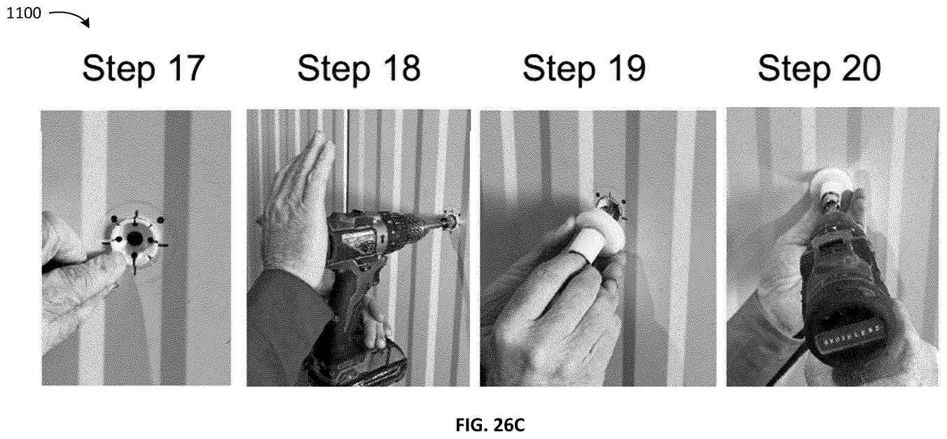

FIG. 25 illustrates an exemplary method 1000 of installing an anchor assembly in a wall structure (e.g., wall structure 102 of FIG. 1) having a laminate outer cover and internal thickness comprised of compressible material, in accordance with embodiments. Portions of the method 1000 may be described with reference to FIGS. 26A, 26B, and 26C, which depict an illustrated installation manual 1100 for installing an anchor assembly in a wall structure . As shown, the manual 1100 contains illustrations for each step of the installation.

In certain embodiments, the method 1000 of installing an anchor assembly includes additional steps that may occur prior to step 1002 of method 1000, for example, as shown in the installation manual 1100. Such additional steps may include marking a center point on a surface of the wall structure, as also shown in Step 1 of FIG. 26A. In certain embodiments, the center point mark indicates a desired entry point for a central anchor of the anchor assembly (e.g., central anchor 210 of anchor assembly 200 shown in FIG. 2) to be installed.

The method 1000 may begin at step 1002 with providing a hole or opening, (e.g., opening 118 shown in FIG. 1) in a laminate outer cover of the wall structure (e.g., thin panel 116 of FIG. 1), the opening having a characteristic diameter. The characteristic diameter may be selected based on one or more attributes of the anchor assembly (e.g., anchor assembly 200), such as, for example, a diameter associated with a washer projection of a washer assembly (e.g., washer assembly 218 as shown in FIG. 2) and/or a diameter associated with an anchor crown (e.g., upper crown 217 shown in FIG. 22). Thus, in some embodiments, the step of providing an opening in the laminate cover includes forming a hole in the laminate cover with a first tool, as also shown in Step 2 of FIG. 26A, and removing inner material of the wall structure with a second tool, as also shown in Step 3 of FIG. 26A. For example, the hole may be created by first drilling through the thin panel from an outer side of the panel (e.g., outer side 119 shown in FIG. 1) using a hole saw of suitable dimensions (e.g., 1-⅛ inch diameter) to a desired depth (e.g., ⅝ inch deep) and then boring through the internal thickness (e.g., the inner portion 114 of the wall structure 102) using a spade bit of suitable dimensions (e.g., 1 inch diameter) to a desired depth (e.g., ⅝ inch deep) to remove a portion of the compressible material therein. The opening may be pre-drilled or may be created during installation of the anchor assembly.

Step 1004 includes providing an anchor assembly (e.g., anchor assembly 200 shown in FIG. 1) having at least one lateral anchor (e.g. lateral anchor 212 shown in FIG. 16) having a generally cylindrical elongated body with a central passageway (e.g., passageway 243 shown in FIG. 17) and an open end (e.g., open top end 245). The at least one lateral anchor has a sidewall (e.g., outer wall 246 shown in FIG. 16) with a generally helical arrangement (e.g., threads 248) projecting radially outward along an extent of the sidewall. In embodiments, the generally helical arrangement of radially outward projections forms an outer threading (e.g., as shown in FIG. 16) for gripping or engaging with the compressible material of the wall structure.

The additional steps of the method 1000 may include providing a central anchor (e.g. central anchor 210 shown in FIG. 7) having a generally cylindrical elongated body with a central passageway (e.g., central passageway 223 shown in FIG. 8) and an open end (e.g., open top end 225). The central anchor has a sidewall (e.g., outer wall 226 shown in FIG. 7) with a generally helical arrangement (e.g., threads 228) projecting radially outward along an extent of the sidewall. In embodiments, the generally helical arrangement of radially outward projections forms an outer threading (e.g., as shown in FIG. 7) for gripping or engaging with the compressible material of the wall structure. According to embodiments, the method 1000 may further comprise providing one or more installation tools for installing or inserting the individual anchors of the anchor assembly into the wall structure.

Step 1006 comprises providing one or more installation tools for installing the anchor assembly in the wall structure. In some embodiments, step 1006 includes providing a central installation tool (e.g., first installation tool 400 shown in FIG. 3) for inserting a central anchor (e.g., central anchor 210 shown in FIG. 7) into the opening formed in the wall structure. The central installation tool (or “central anchor installation tool”) comprises a first elongated plate body (e.g., plate body 410) with a substantially flat lower surface (e.g., lower surface 414 shown in FIG. 4) and an opening (e.g., opening 416 as shown in FIG. 6) formed in the plate body. The central installation tool further comprises a first guide (e.g., guide 402) extending through the opening. The first guide defines a first internal passageway (e.g., internal passageway 420) between a first open end of the first guide (e.g., first open end 418 as shown in FIG. 3) and a second open end of the first guide (e.g., second open end 419). A central axis of the first internal passageway may be substantially perpendicular to the lower surface of the first plate body.

In various embodiments, step 1006 includes providing an angled installation tool (e.g., second installation tool 600 shown in FIG. 11) for inserting one or more lateral anchors (e.g., lateral anchor 212 shown in FIG. 16) into the opening formed in the wall structure. The angled installation tool comprises a second elongated plate body (e.g., plate body 610) having an insertion hole (e.g., major hole 616) and a plurality of alignment holes (e.g., minor holes 617) disposed around the insertion hole, at least one protrusion (e.g., protrusion 619 as shown in FIG. 12) extending from a substantially flat lower surface (e.g., flat lower surface 612) of the second plate body near the major hole, and a second guide (e.g., guide 620 shown in FIG. 11) mounted to an upper surface (e.g., upper surface 611) of the second plate body at an oblique angle (e.g., oblique angle θ as shown in FIG. 15A) relative to the lower surface of the second plate body, the second guide defining a second internal passageway (e.g., internal passageway 626 as shown in FIG. 11) between a first open end (e.g., first open end 622) and a second open end (e.g., second open end 624) positioned adjacent to the major hole.

Step 1007 comprises inserting the central anchor into the internal thickness of the wall structure using a central installation tool. According to embodiments, the inserting at step 1007 may include inserting a bottom portion of the first guide of the central installation tool (e.g., bottom portion 415, or length g of guide 402, shown in FIG. 3) into the opening in the laminate outer cover of the wall structure until the lower surface of the first plate body engages the wall structure (e.g., the outer side 119 shown in FIG. 1), as also shown in Step 4 of FIG. 26A.

Step 1007 may also include guiding the central anchor through the first internal passageway of the guide and into the opening in the wall structure. In some embodiments, the central anchor is guided by attaching a first drive head (e.g., drive head 222 as shown in FIG. 7) of the central anchor to a first driving assembly (e.g., driving assembly 500 as shown in FIG. 9) that is attached to the driving tool, as also shown in Step 5 of FIG. 26A. More specifically, the central anchor may be attached to a first nut driver (e.g., nut driver 540) included in the first driving assembly and sized to receive the first drive head (e.g., 9/16 inch).

Step 1007 can also include threading the central anchor into the wall structure by turning the central anchor to force an extent of the central anchor into the compressible material of the wall structure. In certain embodiments, step 1007 also includes inserting the central anchor into the internal thickness of the wall structure until a head of the central anchor reaches a predetermined depth (e.g., 1 inch) below the surface of the panel (e.g., the outer side 119 of the thin panel 116 of the wall structure 102 as shown in FIG. 1). In embodiments, step 1007 also includes removing the central installation tool from the opening once the central anchor is appropriately positioned within the wall structure.

Step 1008 comprises inserting at least one protrusion of the angled installation tool into the opening in the laminate outer cover of the wall structure until the lower surface of the second plate body engages the wall structure (e.g., the outer side 119 of the thin panel 116 of the wall structure 102 as shown in FIG. 1).

Step 1010 comprises making one or more markings (e.g., with a marking tool such as a pen, pencil, marker, center punch, etc.) on the outer side of the wall structure using one or more of the alignment holes provided on the angled installation tool as a placement guide, as also shown in Step 6 of FIG. 26A. The one or more markings may be made to substantially align with respective alignment holes (e.g., minor hole 617 as shown in FIG. 11). For example, a first mark may substantially align with a center of a first alignment hole, a second mark may substantially align with a center of a second alignment hole, and a third mark may substantially align with a center of a third alignment hole.

In certain alternative embodiments of the method 1000, instead of making a mark, a first edge of the second plate body (e.g., first edge 613 as shown in FIG. 13) is aligned using a first leveling device (e.g., first leveling device 638) attached to the second plate body. In certain embodiments, the first edge is aligned when the first leveling device indicates that the first leveling device is substantially straight in the horizontal direction.

At step 1012, a lateral anchor (e.g., lateral anchor 212 as shown in FIG. 16) of the anchor assembly is guided through the second internal passageway of the second guide, through the insertion hole, and into the opening in the wall structure. In some embodiments, the lateral anchor is guided by first attaching a second drive head (e.g., drive head 242 as shown in FIG. 16) of the lateral anchor to a second driving assembly (e.g., driving assembly 700 as shown in FIG. 19), specifically a second nut driver (e.g., lateral nut driver 1208 shown in FIG. 27D) attached to a driving tool, as also shown in Step 7 of FIG. 26A. In certain embodiments, the second nut driver is sized to receive the second drive head (e.g., ⅜ inches).

At step 1014, the lateral anchor of the anchor assembly is inserted into the internal thickness of the wall structure at the oblique angle formed by the second guide. This step can include threading the lateral anchor into the wall structure by turning the lateral anchor to force an extent of the anchor into the compressible material of the wall structure. In certain embodiments, the lateral anchor is inserted into the internal thickness of the wall structure until the anchor reaches a predetermined depth (e.g., 5- 11/16 inch) below the top of the second guide (e.g., first open end 622 as shown in FIG. 11). In certain embodiments, the predetermined depth is set by a drill stop (e.g., lateral drill stop 730 as shown in FIG. 19).

The method 1000 further comprises, at step 1016, determining whether a desired number of lateral anchors have been installed in the wall structure. If any lateral anchors remain (i.e. the answer to step 1018 is “no”), the method 1000 returns to step 1012 and the next anchor is installed into the wall structure by repeating steps 1012 and 1014. If the desired number of lateral anchors are installed in the wall structure (i.e. the answer at step 1018 is “yes”), the method 1000 may end, in accordance with some embodiments.

Step 1018 comprises rotating the angled installation tool approximately 90 degrees in a first direction. In some embodiments, the angled installation tool is rotated until at least one of the plurality of alignment holes aligns with at least one of the markings on the wall structure. For example, the angled installation tool may be aligned, or in position, when a given marking is visible through the respective alignment hole and the center of that marking aligns with the center of that alignment hole. In certain alternative embodiments of the method 1000 that do not include a mark being made, the angled installation tool may be rotated approximately 90 degrees in a first direction and a second edge of the second plate body (e.g., second edge 614 as shown in FIG. 13) is aligned using a second leveling device (e.g., second leveling device 640) attached to the second plate body. In certain embodiments, the second edge is aligned when the second leveling device indicates that the second leveling device is substantially straight in the horizontal direction.

As shown, once the angled installation tool is rotated and aligned, the method 1000 continues back to step 1012, where a second lateral anchor of the anchor assembly is guided through the internal passageway of the second guide and into the opening in the wall structure, as also shown in Step 7 of FIG. 26A. From step 1012, the method 1000 may continue to step 1014 again, where the second lateral anchor is inserted into the internal thickness of the wall structure at the oblique angle formed by the second guide. From step 1014, the method 1000 may return to step 1016 to repeat the determination of whether the desired number of anchors have been installed. Said cycle may continue until all remaining lateral anchors are installed in the wall structure (i.e. the answer at determination step 1016 is “yes”). For example, in certain embodiments, the anchor assembly includes four lateral anchors and thus, the desired number of anchors is four. In such cases, the method 1000 may repeat steps 1012 to 1018 until all four anchors are installed in the wall structure, as also shown in Steps 9 and 10 of FIG. 26B.

It should be appreciated that the angle to which the angled installation tool is rotated may vary based on the number of desired lateral anchors. For example, the anchor assembly 200 shown in FIG. 2 comprises four lateral anchors 212 and therefore the angled installation tool should be rotated approximately ninety degrees three times to install all four lateral anchors 212, if desired. As another example, the anchor assembly may comprise three lateral anchors equally spaced in the radial direction, and the tool can be rotated approximately 120 degrees two times to install all three desired lateral anchors.

In certain embodiments, the method 1000 may include additional steps after step 1018. For example, such additional steps may include securing a bracket (e.g., bracket 214 as shown in FIG. 20) to the lateral anchors inserted into the wall structure. The bracket may have a plurality sloped walls (e.g., angled walls 260) each defining an aperture (e.g., aperture 258) and providing a plurality of fasteners (e.g., lateral fasteners 216). In certain embodiments, the dimensions of the plurality of fasteners (e.g., #6 size and ⅝ inch length) may be determined based on the central passageway of the lateral anchors such that the fastener can be inserted into said central passageway.

The additional step of securing the bracket may include aligning the bracket with the lateral anchors installed in the wall structure by aligning each aperture with the central passageway of each installed lateral anchor and partially inserting first, second, third, and fourth fasteners into the central passageways of the first, second, third, and fourth lateral anchors, respectively. In certain embodiments, a first tool (e.g., pliers) may be used to hold the bracket in place, as also shown in Step 11 of FIG. 26B, as a second tool (e.g., T-15 driver) may be used to insert each fastener into the central passageway of the corresponding anchor, as also shown in Steps 12 to 15 of FIG. 26B. In certain embodiments, the fasteners should not be fully inserted into the central passageways until all four lateral anchors are appropriately positioned and the bracket is securely in place within the opening. Once the bracket and anchors are in position, the fasteners may be fully inserted into the central passageways of the first, second, third, and fourth lateral anchors, respectively. In certain embodiments, the fasteners may be installed to certain specifications (e.g., tightened in each central passageway to a torque of 4 inch-pounds) with an appropriate tool (e.g., a torque wrench).

In some embodiments, for example, where the method 1000 includes inserting the central anchor into the wall structure, the additional steps of the method 1000 may include adjusting, or backing out, the central anchor until the central anchor engages the bracket, as also shown in Step 16 of FIG. 26B. For example, such step may include engaging a portion (e.g., female hex portion 221 as shown in FIG. 8) of the central anchor with a tool to rotate the central anchor in a second direction, where the second direction is opposite the first direction used to install the central anchor. In certain embodiments, the portion of the central anchor comprises a female hex configured for engagement with a hex wrench having corresponding dimensions (e.g. 3/16 inch). In certain embodiments, the step of backing out the central anchor further comprises rotating the central anchor in the second direction until the anchor engages the bracket. Engagement between the anchor and the bracket may ensure that the anchors (e.g., central anchor 210 and the four lateral anchors 212) of the anchor assembly collectively bear a tension load placed on the anchor assembly.

According to embodiments, the additional steps of the method 1000 may include installing an annular collar (e.g., upper crown 217 as shown in FIG. 23) in the opening such that a lower edge (e.g., lower edge 288) of the annular collar engages the bracket and a top edge (e.g., top rim 283) engages an inner side of the laminate panel, as also shown in Steps 17 and 18 of FIG. 26C.

The additional steps of the method 1000 may include coupling an external assembly (e.g., external assembly 206 as shown in FIG. 1) of the anchor assembly to an internal assembly (e.g., internal assembly 204) of the anchor assembly using an elongated fastener (e.g., elongated fastener 202), as also shown in Steps 19 and 20 of FIG. 26C. In certain embodiments, the external assembly comprises a washer assembly (e.g. washer assembly 218 as shown in FIG. 2) and a spacer (e.g., spacer 219) and the internal assembly comprises the anchors, the bracket, the fasteners, and the annular collar. In certain embodiments, the method 1000 includes inserting the elongated fastener through a respective opening in each of the washer assembly, the spacer, the annular collar, and the bracket to secure the elongated fastener in the central passageway (e.g., central passageway 223 shown in FIG. 8) of the anchor (e.g., central anchor 210).

The additional steps of the method 1000 may include securing the elongated fastener in the central passageway of the central anchor. In certain embodiments, the fasteners may be secured to certain specifications (e.g., tightened in the central passageway to a torque of 4 foot-pounds) with an appropriate tool (e.g., a torque wrench).

In certain embodiments, the method 1000 may end once the elongated fastener is secured.

FIG. 27A is a top perspective view of an exemplary installation kit 1200 for installing an anchor assembly (e.g., anchor assembly 200 of FIG. 2) in a wall structure having an outer wall panel and an internal thickness (e.g., wall structure 102 of FIG. 1) using a driving tool, in accordance with certain embodiments. The driving tool may be similar to the driving tool 510 shown in FIG. 9 (e.g., a drill), or may be any other suitable tool (e.g., screwdriver, etc.). The kit 1200 comprises a plurality of components or tools configured to facilitate installation of the anchor assembly such as, for example, a driver or other suitable tool for inserting each anchor of the anchor assembly into the wall structure, one or more screws or other fasteners for coupling together the components of the anchor assembly once installed in the wall structure, and more. In embodiments, the various components of the kit 1200 may be provided or packaged together as a collection of components for fully installing the anchor assembly, or as a collection of components that can be used for installing various different assemblies, including the anchor assembly.

The installation kit 1200 is configured for use in conjunction with and/or in addition to the first installation tool 400 (e.g., as shown in FIG. 3) and the second installation tool 600 (e.g., as shown in FIG. 11). In some embodiments, the installation kit 1200 comprises the first installation tool 400 and/or the second installation tool 600, in addition to a plurality of accessory components, which may include, for example, a hole saw 1202, a spade 1204, a driving assembly 1206 comprising a lateral nut driver 1208 and a central nut driver 1210, and a hex wrench 1212, as shown in FIG. 27A. In other embodiments, the installation kit 1200 may only include the accessory components, and the installation tools 400 and 600 may be provided or sold separately.

FIG. 27B is a close-up view of the hole saw 1202. According to embodiments, the hole saw 1202 is attachable to the driving tool (e.g., driving tool 510 shown in FIG. 9) and configured to make an initial or preliminary hole in the outer panel of the wall structure (e.g., thin panel 116 shown in FIG. 1) for installation of the anchor assembly. As illustrated in FIG. 27B, the hole saw 1202 includes a first connection end 1214 configured to be fixedly attached to the driving tool and a first cutting end 1216 configured to drill through the outer panel of the wall structure from an outer side of the panel (e.g., outer side 119 shown in FIG. 1). The first cutting end 1216 of the hole saw 1202 has a diameter that is suitable to create the preliminary hole for installation of the anchor assembly. In some embodiments, the hole saw 1202 includes a guide drill bit 1217 configured to guide the hole saw 1202 into the outer panel and prevent wandering as the first cutting end 1216 drills into the outer panel. In some embodiments, the hole saw 1202 includes a hole saw stop 1218 configured to stop the hole saw 1202 from advancing beyond a desired depth into the outer panel. The hole saw stop 1218 may be configured to stop the path of the driving tool when the hole saw stop 1218 contacts the outer panel of the wall structure.

FIG. 27C is a close-up view of the spade 1204. According to embodiments, the spade 1204 is attachable to the driving tool and configured to make a further hole or opening into the inner thickness of the wall structure for installation of the anchor assembly. That is, the spade 1204 may be used to deepen the preliminary hole in the outer panel until it extends into inner thickness of the wall structure, for example, like the opening 118 shown in FIG. 1. As illustrated in FIG. 27C, the spade 1204 includes a second connection end 1220 configured to be fixedly attached to the driving tool and a second cutting end 1222 configured to bore through the internal thickness of the wall structure. The spade 1204 is configured to have dimensions suitable for creating a bore into the internal thickness that is sufficient for installing the anchor assembly. In some embodiments, the spade 1204 includes a spade stop 1224 configured to stop the spade 1204 from advancing beyond a desired depth into the internal thickness. The spade stop 1224 may be configured to stop the path of the driving tool when the spade stop 1224 contacts the wall structure.

FIG. 27D is a close-up view of the driving assembly 1206 coupled to the lateral nut driver 1208. FIG. 27E is a close-up view of the driving assembly 1206 coupled to the central nut driver 1210. In embodiments, the driving assembly 1206 may be substantially similar to the driving assembly 500 shown in FIG. 9 and/or the driving assembly 700 shown in FIG. 19, depending on which nut driver is attached. For example, like the driving assemblies 500 and 700, the driving assembly 1206 comprises a shank 1226 configured for attachment to the driving tool (e.g., similar to the shank 520 and/or the shank 720). The shank 1226 comprises an elongated body 1227 extending between a first end 1228 and a second end 1230 opposite the first end 1228. The second end 1230 is configured to be removably coupled to the driving tool.

According to embodiments, the shank 1226 may be interchangeably coupled to the lateral nut driver 1208 and the central nut driver 1210. In particular, the first end 1228 of the shank 1226 may be configured for removable attachment to either the lateral nut driver 1208 or the central nut driver 1210. In such cases, the lateral nut driver 1208 and the central nut driver 1210 may be independent components that can be separated from the rest of the driving assembly 1206, e.g., as shown in FIG. 27A.

Like the lateral nut driver described herein with respect to FIG. 19, the lateral nut driver 1208 is configured to engage a drive head of a lateral anchor of the anchor assembly (e.g., lateral anchor 212 shown in FIG. 16). In embodiments, a first end 1232 of the lateral nut driver 1208 is configured to be removably coupled to the first end 1228 of the shank 1226 and a second end 1234 of the lateral nut driver 1208 is configured to engage the drive head of the lateral anchor. Similarly, like the central nut driver 540 shown in FIG. 9, the central nut driver 1210 is configured to engage a drive head of a central anchor of the anchor assembly (e.g., central anchor 210 shown in FIG. 7). In embodiments, a first end 1236 of the central nut driver 1210 is configured to be removably coupled to the first end 1228 of the shank 1226 and a second end 1238 of the central nut driver 1210 is configured to engage the drive head of the lateral anchor.

The driving assembly 1206 further comprises a drill stop 1240 coupled to the shank 1226. As shown in FIGS. 27D and 27E, the drill stop 1240 may be attached to the body 1227 of the shank 1226 between the first end 1228 and the second end 1230. The drill stop 1240 may be configured to stop a path of the driving tool during installation of an anchor (i.e. the lateral anchor or the central anchor) coupled to the shank 1226, via the appropriate nut driver, for example, similar to the central drill stop 530 shown in FIGS. 10A and 10B and/or the lateral drill stop 730 shown in FIG. 19. As shown, the drill stop 1240 comprises a stop protrusion 1246 that is configured to stop the path of the driving tool once the anchor reaches a desired depth into the internal thickness of the wall structure (e.g., similar to stop protrusion 550 shown in FIG. 9 and/or stop protrusion 750 shown in FIG. 19).

As shown in FIG. 27E, the drill stop 1240 comprises a central aperture 1242 configured to receive the body 1227 of the shank 1226, and one or more fasteners 1244 configured to fixedly attach the drill stop 1240 to the body 1227 at a pre-selected or desired position along the shank 1226. In embodiments, the one or more fasteners 1244 may include screws that can be manually tightened or adjusted to secure the drill stop 1240 to the body 1227 at the desired position. The desired position of the drill stop 1240 along the shank body 1227 may be determined based on a target installation position of each anchor within the internal thickness of the wall structure, as described herein.

According to embodiments, the drill stop 1240 may be configured to facilitate two separate operations: (1) position a central anchor at a first depth within the internal thickness of the wall structure, when the central nut driver 1210 is attached to the shank 1226, and (2) position a lateral anchor at a second depth within the internal thickness of the wall structure, when the lateral nut driver 1208 is attached to the shank 1226. During the first operation, the drill stop 1240 is configured to stop the path of the driving tool once the central anchor coupled to the driving assembly 1206 reaches the first depth (or desired depth) associated with the central anchor. During the second operation, the drill stop 1240 is configured to stop the path of the driving tool once the lateral anchor coupled to the driving assembly 1206 reaches the second depth associated with the lateral anchor.

In embodiments, various dimensions of the stop protrusion 1246 may be configured or selected to facilitate the first and second operations of the drill stop 1240 and may depend on the specific dimensions of the first installation tool 400 and the second installation tool 600. For example, in the illustrated embodiment, the stop protrusion 1246 is substantially cylindrical and the outer diameter of the stop protrusion 1246 is at least slightly larger than relevant dimensions of both the first installation tool 400 and second installation tool 600. Such dimensions may include, for example, a diameter of the first guide 402, and/or the first internal passageway 420 thereof, and a diameter of the second guide 620, and/or the second internal passageway 626 thereof. In some embodiments, the diameter of the stop protrusion 1246 may be sized to prevent the stop protrusion 1246 from entering either the first internal passageway 420 or the second internal passageway 626 during installation of a given anchor, for example, as shown in FIGS. 10B and 19. For example, if the two tools have different dimensions, the stop protrusion 126 may be sized according to the smaller of the two.

In other embodiments, the stop protrusion 1246 comprises a non-cylindrical shape, such as a cube or triangular prism, for example, and relevant dimensions of such shape of the stop protrusion 1246 may be configured to prevent at least a portion of the stop protrusion 1246 from entering the first internal passageway 420 or the second internal passageway 626 during installation of the anchor.

In some embodiments, the installation kit 1200 may comprise a plurality of drill stops that can be interchangeably coupled to the shank 1226 depending on the particular dimensions of the installation tool. For example, the installation kit 1200 may include a first drill stop configured specifically for installation of the central anchor (e.g., similar to central drill stop 530 shown in FIG. 9) and a second drill stop configured specifically for installation of the lateral anchor (e.g., similar to lateral drill stop 730 as shown in FIG. 19). In such cases, the diameter of each drill stop may be tailored according to the diameter of the internal passageway of the relevant installation tool (e.g., tool 400 or 600).

The hex wrench 1212 is configured to adjust, or back out, the central anchor until the central anchor engages a bracket of the anchor assembly (substantially similar to the process shown in Step 16 of FIG. 26B). The hex wrench 1212 is configured to engaging a female hex portion of the central anchor to rotate the central anchor in a second direction opposite the first direction used to install the central anchor. The hex wrench 1212 may be suitably sized to engage the female hex portion of the central anchor.

It should be emphasized that the above-described embodiments, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and protected by the following claims.

I claim:

1. An installation tool for installing an anchor assembly in a wall structure, the installation tool comprising:
a plate body configured to engage the wall structure during installation of the anchor assembly, the plate body defining a major hole and a plurality of minor holes positioned adjacent to the major hole;
at least one protrusion positioned adjacent to the major hole and extending substantially perpendicular to a substantially flat lower surface of the plate body, the at least one protrusion configured for insertion into the wall structure during said installation;
a guide having a first open end and an opposing second open end positioned adjacent to the major hole, the guide defining an internal passageway between the first open end and the second open end, wherein a central axis of the internal passageway extends at an oblique angle relative to the lower surface of the plate body; and
a support configured to fixedly attach the guide to an upper surface of the plate body.

2. The installation tool of claim 1, wherein the installation tool is made of stainless steel.

3. The installation tool of claim 1, wherein the installation tool further comprises a first leveling device fixedly attached to the upper surface of the plate body.

4. The installation tool of claim 3, wherein the installation tool further comprises a second leveling device fixedly attached to the upper surface of the plate body, the first leveling device configured to extend longitudinally in a horizontal direction and the second leveling device configured to extend longitudinally in a vertical direction.

5. The installation tool of claim 1, wherein the installation tool further comprises a mounting area configured to receive one or more leveling devices.

6. The installation tool of claim 1, wherein the plate body comprises a first edge, a second edge, and a third edge, the first edge substantially perpendicular to the second edge.

7. The installation tool of claim 6, wherein the third edge has a curvilinear extent between the first edge to the second edge.

8. The installation tool of claim 6, wherein a first minor hole of the plurality of minor holes is substantially aligned with a meeting point of the first edge and the second edge.

9. The installation tool of claim 8, wherein a second minor hole of the plurality of minor holes is positioned approximately 90 degrees offset from the first minor hole relative to a central axis of the major hole.

10. The installation tool of claim 1, wherein the major hole is sized and shaped to receive an anchor during installation of the anchor assembly.

11. The installation tool of claim 1, wherein the at least one protrusion comprises a first protrusion aligned with a first side of the major hole and a second protrusion aligned with a second opposing side of the major hole.

12. The installation tool of claim 1, wherein the internal passageway of the guide is sized and shaped to receive an anchor during installation of the anchor assembly.

13. The installation tool of claim 1, wherein the oblique angle is approximately 53 degrees.

14. An installation tool for installing an anchor in a wall structure, the installation tool comprising:
a plate body configured to engage the wall structure during installation of the anchor, the plate body defining an opening and having a substantially flat lower surface opposite an upper surface; and
a guide extending through the opening in the plate body and having a first open end located a first distance above the upper surface of the plate body and a second open end located a second distance below the lower surface of the plate body, the first distance being greater than the second distance,
wherein the guide defines an internal passageway between the first open end and the second open end, and a central axis of the internal passageway is substantially perpendicular to the lower surface of the plate body.

15. The installation tool of claim 14, wherein the installation tool is made of stainless steel.

16. The installation tool of claim 14, wherein the plate body is substantially circular.

17. The installation tool of claim 14, wherein the internal passageway of the guide is sized and shaped to receive the anchor during installation of the anchor.

18. A method for installing an anchor assembly in a wall structure having an outer wall panel and an internal thickness, the method comprising:
providing an angled installation tool, the angled installation tool comprising: a plate body having a major hole and a plurality of minor holes disposed around the major hole, at least one protrusion extending from a substantially flat lower surface of the plate body near the major hole, and a guide mounted to a upper surface of the plate body at an oblique angle relative to the lower surface of the plate body, the guide defining an internal passageway between a first open end and a second open end positioned adjacent to the major hole;
inserting the at least one protrusion of the angled installation tool into an opening formed in the wall structure until the lower surface of the plate body engages the wall structure;
guiding a first lateral anchor of the anchor assembly through the internal passageway of the guide, through the major hole, and into the opening in the wall structure; and
inserting the first lateral anchor into the internal thickness of the wall structure at the oblique angle formed by the guide.

19. The method of claim 18, further comprising providing the opening in the wall structure.

20. The method of claim 18, further comprising providing the anchor assembly, the anchor assembly comprising a plurality of anchors including the first lateral anchor.

21. The method of claim 18, further comprising:
providing a central installation tool, the central installation tool comprising a second plate body with a substantially flat lower surface and a second guide extending through an opening in the second plate body such that a first open end of the second guide extends a first distance above the second plate body and a second open end of the second guide extends a second distance below the second plate body, the second guide defining a second internal passageway between the first open end and the second open end of the second guide;
inserting the second open end of the second guide into the opening formed in the wall structure until the lower surface of the second plate body engages the wall structure;
guiding a central anchor of the anchor assembly through the second internal passageway, through the second open end, and into the opening in the wall structure; and
inserting the central anchor into the internal thickness of the wall structure.

22. The method of claim 18, wherein inserting the first lateral anchor comprises inserting the first lateral anchor into the internal thickness of the wall structure until the anchor reaches a predetermined depth.

23. The method of claim 18, further comprising:
rotating the installation tool approximately 90 degrees in a first direction;
guiding a second lateral anchor of the anchor assembly through the internal passageway of the guide, through the major hole, and into the opening in the wall structure; and
inserting the second lateral anchor into the internal thickness of the wall structure at the oblique angle formed by the guide.

24. The method of claim 23, wherein rotating the installation tool comprises rotating the installation tool until a leveling assembly attached to the plate body indicates alignment of an edge of the plate body with the wall structure.

25. The method of claim 23, further comprising making one or more markings on the wall structure by using one or more of the minor holes as a placement guide.

26. The method of claim 25, wherein rotating the installation tool comprises rotating the installation tool until at least one of the plurality of minor holes aligns with at least one of the one or more markings on the wall structure.
